(19) United States
(12) Patent Application Publication
(10) Pub. No.: US 2025/0188861 A1
(43) Pub. Date: Jun. 12, 2025

(54) Turbine Dosing System

(71) Applicants: Cummins Ltd, London (GB); Cummins Emission Solutions, Inc., Columbus, IN (US)

(72) Inventors: Samuel Johnson, Columbus, IN (US); Chetan Kishorrao Chawane, Pune (IN); Ameya Navnath Warang, Pune (IN); Paul T. Frisch, Columbus, IN (US); Matthew Robert Brookes, West Yorkshire (GB); Atif Mahmood, West Yorkshire (GB)

(21) Appl. No.: 18/846,255

(22) PCT Filed: Mar. 16, 2023
(86) PCT No.: PCT/GB2023/050633

§ 371 Date: Sep. 12, 2024

(30) Foreign Application Priority Data
Mar. 17, 2022 (GB) 2203712.1

(51) Int. Cl. F01N 3/20; F01D 9/02; F01D 25/24; F01D 25/30

(52) U.S. Cl. CPC F01N 3/208; F01D 9/02; F01D 25/24; F01D 25/30; F05D 2220/40; F05D 2230/60; F05D 2260/60

(57) ABSTRACT

There is disclosed a turbine dosing system for a turbocharger. The turbine dosing system comprises a turbine inlet passage (112), a turbine wheel chamber and a turbine outlet passage (116). The turbine inlet passage is configured to receive exhaust gas from an internal combustion engine. The turbine wheel chamber is configured to receive exhaust gas from the turbine inlet passage. The turbine wheel chamber contains a turbine wheel supported for rotation about a turbine wheel axis. The turbine wheel comprises an exducer defining an exducer diameter. The turbine outlet passage is downstream of the turbine wheel chamber and is configured to receive exhaust gas from the turbine wheel chamber. The turbine outlet passage is at least partly defined by a structure which comprises a dosing module mount (122) configured to receive a dosing module (32). The turbine outlet passage defines a flow axis which extends from a downstream end of the turbine wheel. The dosing module mount is located within around 10 exducer diameters, along the flow axis, downstream of the downstream end of the turbine wheel.

The present invention relates to a turbine dosing system, a turbocharger, an engine arrangement, a turbine housing, a connection adapter, an aftertreatment fluid dosing conduit and an associated method.

Turbochargers are used within internal combustion engine systems to increase the pressure of the intake air entering the internal combustion engine to a pressure above atmospheric pressure. This is known as a “boost pressure”. By increasing the pressure of the intake air entering the internal combustion engine, more oxygen is available within the internal combustion engine to support the combustion of a larger amount of fuel, and therefore increases the amount of power produced by the engine.

Turbochargers comprise a compressor and a turbine. The compressor comprises a compressor wheel configured to impart energy to an incident fluid stream, and the turbine comprises a turbine wheel configured to extract energy from an incident fluid stream. The compressor wheel and the turbine wheel are attached to opposite ends of a turbocharger shaft, such that the two rotate in unison. The compressor receives intake air from the atmosphere and delivers the intake air to an intake manifold of the internal combustion engine. The turbine receives exhaust gas from an exhaust manifold of the internal combustion engine and delivers the exhaust gas to an aftertreatment system. During use, exhaust gas leaving the internal combustion engine passes through the turbine, causing the turbine wheel to rotate. The rotation of the turbine wheel drives the compressor wheel, which acts to compress the intake air as it is delivered to the intake manifold.

Exhaust gases from internal combustion engines contain substances that are harmful to the environment. Most countries have vehicle emission standards which limit the amount of such substances that an internal combustion engine system is permitted to emit. Consequently, modern internal combustion engine systems comprise exhaust gas aftertreatment systems designed to remove harmful substances from the exhaust gas.

Typically, an exhaust gas aftertreatment system will comprise a particulate filter and one or more catalytic reducers. The particulate filter removes heavy combustion products, e.g. soot, from the exhaust gas. The catalytic reducers remove harmful substances such as Nitrogen Oxides (NOx) from the exhaust gas. Catalytic reducers generally comprise a large number of narrow channels made from a material selected to support a chemical reaction that removes NOx from the exhaust gas. The narrow channels provide a large surface area for the catalytic reaction to take place. Several kinds of catalytic reducers are available on the market, such as two-way catalytic reducers, three-way catalytic reducers, diesel oxidation catalytic reducers (DOCs), and selective catalytic reducers (SCRs). DOCs and SCRs are typically employed in diesel engine systems. For the SCRs specifically, in order for the SCR reaction to work, it is necessary to mix an exhaust gas aftertreatment fluid with the exhaust gas before it enters the catalytic reducer. The exhaust gas aftertreatment fluid is usually a mixture of around 30% to 35% by volume urea (CO(NH₂)₂) to about 65% to 70% by volume deionised water (H₂O). The exhaust gas aftertreatment fluid is often referred to as Diesel Exhaust Fluid (DEF) and is commonly available under the registered trademark AdBlue.

Conventionally, the DEF is mixed with the exhaust gas in a decomposition chamber. The DEF is injected into the decomposition chamber using a dosing module. In the decomposition chamber, heat is exchanged from the exhaust gas to the DEF which causes the water within the DEF to evaporate and the urea to thermally decompose into the reductants ammonia (NH₃) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

If the exhaust gas and DEF are not mixed well enough, the heat exchange between the DEF and the exhaust gas will not be sufficient to decompose the DEF into the required reductants. Furthermore, poor mixing means that the reductants are not evenly distributed within the flow, and therefore some channels of the catalytic reducer will not receive enough reductant to support the SCR reaction. To ensure adequate mixing, it is common for the decomposition chamber to comprise a mixing plate configured to generate additional turbulence. However, the additional turbulence caused by the mixing plate and the fluidic friction exerted by the mixing plate on the exhaust gas creates a back-pressure on the exhaust gas in the decomposition chamber. This back pressure is passed upstream and acts to increase the pumping work required by the internal combustion engine, and accordingly reduces the overall efficiency of the engine system. Accordingly there is need for improvement in this technical area.

There exists a need to provide alternative systems which overcome one or more of the disadvantages of known systems, whether mentioned in this document or otherwise.

According to a first aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter; and
a turbine outlet passage downstream of the turbine wheel chamber and configured to receive exhaust gas from the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 10 exducer diameters, along the flow axis, downstream of the downstream end of the turbine wheel.

The turbine dosing system may comprise a radial turbine. The turbine dosing system may comprise an axial turbine. The turbine dosing system may form part of a turbocharger dosing system. The turbine dosing system may form part of a turbo-compound system (e.g. a system in which a turbine delivers mechanical work to a crankshaft of an engine, either instead of, or in addition to, a compressor). The turbine dosing system may be referred to as a turbine (e.g. a turbine for a turbine dosing system) in the absence of a dosing module.

The turbocharger, specifically a turbine thereof, may be a fixed geometry turbine or a variable geometry turbine. The turbocharger, specifically the turbine thereof, may incorporate a wastegate.

The turbine inlet passage may be defined by a volute. The volute defines a generally spiralling geometry which varies in cross-section along its extent. The term “passage” refers to a volume, defined or bound by a surrounding structure, through which fluid can flow.

The turbine wheel chamber refers to a volume which contains the turbine wheel. A downstream end of the turbine wheel chamber may lie in the plane of the downstream end of the turbine wheel. An opposing end of the turbine wheel chamber may lie in the plane of a rear face of a hub of the turbine wheel.

The term “exducer” refers to the portion of the turbine wheel which discharges exhaust gas. Described another way, the term “exducer” encompasses the part of the turbine wheel which functions as the outlet of the turbine wheel (i.e. the distal end of the turbine wheel from the perspective of the turbine bulk flow travelling therethrough). The exducer diameter refers to a diameter of the turbine wheel at a downstream-most point of the blades. Described another way, the term “exducer diameter” encompasses the diameter of the exducer, at the most distal part of the turbine wheel from the perspective of the turbine bulk flow. The turbine wheel may further comprise an inducer, through which exhaust gas enters the turbine wheel.

The turbine wheel may be a radial turbine wheel comprising an inducer and an exducer. A radial turbine wheel may be configured to receive incident exhaust gas (at the inducer thereof) in a radial direction in relation to the turbine wheel axis. The “exducer” is not intended to refer to features of the turbine wheel which do not act to discharge exhaust gas into the turbine outlet passage (e.g. wheel nuts, aftertreatment dosing cups or the like). The turbine wheel may be a cupless turbine wheel (e.g. where the wheel hub does not having a dosing cup, into which aftertreatment fluid is injected, which atomises the aftertreatment fluid before it is dispersed into the exhaust gas). A turbine wheel incorporating such a cup may be referred to as a radial slinging atomiser, a radial atomiser, a centrifugal atomiser or a rotating atomiser.

The term “flow axis” refers to an axis about which the exhaust gas in the turbine outlet passage generally rotates as it flows through the turbine outlet passage (along the flow axis). It will be appreciated that the flow axis, in contrast to the turbine wheel axis, need not be a straight, linear axis. The flow axis may be at least partly arcuate. The flow axis may be described as an imaginary line drawn along, and through, the turbine outlet passage, the line being positioned at the (nominal) geometric centre of the turbine outlet passage. The flow axis may vary depending upon the geometry of the structure which defines the turbine outlet passage. By way of example, if the turbine outlet passage comprises a bend, the flow axis may also comprise a bend (e.g. be at least partly arcuate) as the direction of the exhaust gas flow in the turbine outlet passage would be forced to change due to the bend in the turbine outlet passage. The flow axis may be said to define a fluid flowpath which is generally followed by the turbine bulk flow once it has travelled downstream of the downstream end of the turbine wheel. For at least a portion of an extent of the flow axis, the flow axis may be coincident with the turbine wheel axis. The flow axis may extend from the turbine wheel axis.

The term “turbine outlet passage” encompasses any flowpath configured to receive exhaust gas that has passed through the turbine wheel at a position downstream, preferably immediately downstream, of the turbine wheel chamber. The purpose of the turbine outlet passage is to handle and/or condition the exhaust gas flow in the region where swirl and flow velocity are highest. A “turbine outlet passage” according to the invention may comprise structures configured to condition the exhaust gas flow, for example, structures configured to by dissipate swirl, such as fins, or to decelerate flow, such as a diffuser. However, the term “turbine outlet passage” is not intended to encompass flow passages positioned significantly downstream of the turbine wheel chamber (e.g. which handle exhaust gas flow once swirl has dissipated or once the flow has been decelerated). The turbine outlet passage may be considered to start at a downstream end (e.g. downstream-most tip, or outer tip) of the turbine wheel, and may extend by no more than around 10 exducer diameters, along the flow axis, from the downstream end of the turbine wheel. The turbine outlet passage may extend by no more than around 7 exducer diameters, along the flow axis, from the downstream end of the turbine wheel. The turbine outlet passage may extend by no more than around 3 exducer diameters, along the flow axis, from the downstream end of the turbine wheel. An effective end of the turbine outlet passage may be defined by the point at which the passage ceases to diverge (e.g. where the cross section area of the passage, normal to the flow axis, becomes constant). This may be described as the end of a diffuser portion, or diverging portion. The turbine outlet passage may diverge along its entire extent (e.g. axial length along the flow axis). The turbine outlet passage may diverge along at least a portion of its extent.

The turbine wheel may be secured to a shaft by a turbine wheel nut. The wheel nut may be coaxial with the turbine wheel axis, and be configured to rotate about the turbine wheel axis. The turbine wheel nut may define an effective end face, or a downstream-most end, of the turbine wheel. The dosing module mount may be provided within around 7 exducer diameters along the flow axis from the end face of the turbine wheel nut.

The structure may be a wall. The structure may be part of a turbine housing, connection adapter or conduit. A turbine housing may thus comprise the dosing module mount. A connection adapter may comprise the dosing module mount. Alternatively, a conduit may comprise the dosing module mount. The dosing module may thus be mounted to a turbine housing, connection adapter or conduit.

The term “dosing module mount” encompasses a structure which is configured to align, and support, a dosing module. The dosing module mount may be integrally formed with the structure, which at least partly defines the turbine outlet passage, or may be attached to the structure by a joining process such as, for example, welding or brazing. Given that the dosing module mount is configured to receive a dosing module, it will be appreciated that the position of the dosing module mount, e.g. the opening thereof, is indicative of the position of the dosing module once received therein. The dosing module mount position therefore defines the location of the dosing module and the aftertreatment fluid injection (e.g. a primary impingement zone as defined by a spray cone of the dosing module) in the assembled dosing system. The primary impingement zone is preferably entirely downstream of the turbine wheel chamber. The primary impingement zone is preferably located entirely within the turbine outlet passage.

As used herein, the term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The dosing module may be provided in fluid communication with a tank, or reservoir, in which a supply (e.g. volume) of aftertreatment fluid is stored. Actuation of the dosing module (e.g. injection) may be controlled by a controller. The controller may be an Engine Control Unit (ECU) or be linked (e.g. electrically coupled) to the ECU.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The distance of the dosing module mount downstream of the downstream end of the turbine wheel may specifically refer to the position of a centroid of an opening of the dosing module mount along the flow axis, when taken at a shortest distance to the flow axis.

Conventionally, aftertreatment fluid is mixed with the exhaust gas in a decomposition chamber and the aftertreatment fluid is injected into the decomposition chamber using a dosing module. Known decomposition chambers are located near a vehicle exhaust pipe (e.g. at a significant distance downstream of the engine). In the decomposition chamber, heat is exchanged from the exhaust gas to the DEF which causes the water within the DEF to evaporate and the urea to thermally decompose into the reductants ammonia (NH₃) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

Exhaust gas in the turbine outlet passage has a higher temperature than exhaust gas downstream of the turbine outlet passage, which will lose energy due to transient thermal dissipation, pipe friction and the like. When aftertreatment fluid is injected into the turbine outlet passage, the higher temperature of the exhaust gas in the turbine outlet passage encourages the aftertreatment fluid to decompose faster, and more completely, compared to DEF injection into a downstream decomposition chamber. As such, in many cases the need for a mixing plate and/or a decomposition chamber can be eliminated.

Providing the dosing module mount, and so dosing module, in the turbine outlet passage is also advantageous for reasons of packaging (i.e. in that components which may otherwise be required can be omitted from the system). Providing the dosing module mount in relative proximity to the engine also means that the lengths of electrical and coolant lines can be reduced, providing cost benefits. The turbine outlet passage is also a region in which the exhaust gas, having been expanded through the turbine wheel, has a relatively high swirl. The high swirl creates regions of high turbulent kinetic energy (TKE) in the flow, which is beneficial in thoroughly mixing the reductant fluid with, and distributing the reductant fluid within, the exhaust gas flow. Locating the dosing module mount, and so dosing module, within around 10 exducer diameters, along the flow axis, downstream of the downstream end of the turbine wheel is therefore advantageous for at least the above reasons.

Incorporating the dosing module mount in the turbine outlet passage provides a convenient means of aligning, and securing, the dosing module to the turbine outlet passage.

The turbine dosing system may further comprise a dosing module mounted to the dosing module mount and configured to inject aftertreatment fluid, via an outlet of the dosing module, into exhaust gas in the turbine outlet passage.

The term “outlet” refers to the part of the dosing module from which the aftertreatment fluid leaves (i.e. is expelled from) the dosing module. That is to say, the part of the dosing module from which aftertreatment fluid emanates. The outlet may be, for example, an aperture. The outlet may be defined in a nozzle of the dosing module. The dosing module being configured to inject aftertreatment fluid into the exhaust gas in the turbine outlet passage is intended to mean that the dosing module injects aftertreatment fluid directly into at least a turbine bulk flow (e.g. core exhaust flow).

The dosing module may be located within around 10 exducer diameters, around 7 exducer diameters, around 5 exducer diameters, and around 3 exducer diameters downstream of the downstream end of the turbine wheel. The dosing module may be located at least around 1 exducer diameter downstream of the downstream end of the turbine wheel. The dosing module is preferably located between around 1 exducer diameter, and around 3 exducer diameters, downstream of the downstream end of the turbine wheel.

The distance of the dosing module downstream of the downstream end of the turbine wheel may specifically refer to the position of a centroid of the outlet of the dosing module along the flow axis, when taken at a shortest distance to the flow axis. A position of the dosing module (e.g. a centroid of an outlet thereof) may be substantially the same as a position as the dosing module mount (e.g. a centroid of an opening thereof).

The dosing module mount may comprise an engagement surface; and
the dosing module may engage the engagement surface.

The term “engagement surface” encompasses any surface of the dosing module mount which contacts the dosing module. The engagement surface may define a complementary (e.g. opposing) surface to a surface of the dosing module. The engagement surface may be a flange. The engagement surface may comprise discontinuities, for example openings or threaded holes, which may extend through the surface and may allow the dosing module to be connected to the dosing module mount.

The dosing module may be secured to the dosing module mount by a number of types of retention means. The dosing module may be retained by way of an interference fit with the engagement surface of the dosing module mount. Alternatively, the dosing module may be retained by a threaded engagement with the engagement surface. Further alternatively, the dosing module may be retained by fasteners. Suitable fasteners include bolts and screws. In a further example, the dosing module may be secured to the engagement surface through use of a clamp (e.g. a V-band clamp) which is configured to exert a force between the dosing module and the engagement surface.

The engagement surface may not directly engage the dosing module. For example, a gasket, such as a graphite gasket, may be provided between the dosing module and the engagement surface.

The provision of an engagement surface advantageously means that the dosing module can be readily engaged with and, if needed, disengaged from, the turbine outlet passage. This is particularly beneficial during assembly, maintenance, testing and/or repair of the turbine dosing system (specifically the dosing module thereof).

The dosing module mount may comprise a boss.

As used herein, the term “boss” encompasses a protruding structure. The boss may extend in a direction away from the structure which at least partly defines the turbine outlet passage. In particular, the boss may extend in a radial direction from the turbine outlet passage relative to the turbine wheel axis and/or flow axis.

The boss may comprise a bore which is configured to receive a portion of the dosing module. In particular, the bore may receive a nozzle of the dosing module. The bore may define an internal surface of the boss. Said internal surface may be a threaded surface. The threaded surface of the bore may be configured to engage with a complementary threaded surface, provided on the dosing module, or on an interposing connector, to attach the dosing module to the dosing module mount.

The boss may further comprise, or alternatively comprise, an external threaded surface. The external threaded surface may define an engagement surface with which a threaded surface of the dosing module, or a connector, can threadably engage to secure the dosing module to the dosing module mount.

A benefit of the dosing module mount comprising a boss is that the dosing module does not need to extend (i.e. project) into the turbine outlet passage (and have exhaust gas in the turbine outlet passage impinge upon it). Put another way, the dosing module may be recessed relative to the turbine outlet passage. Undesirable disturbance to the exhaust gas flow in the turbine outlet passage, which may cause an unwanted backpressure with associated efficiency reductions, can thus be avoided.

The use of a boss is also beneficial in that the dosing module may be externally mounted to the structure defining the turbine outlet passage. Externally mounting the dosing module provides improved accessibility for an operator when inspecting, installing and removing the dosing module from the dosing module mount.

The boss may comprise a flange, and a face of the flange may define the engagement surface.

The flange may be a projecting rim or collar. The flange may be provided at a distal end of the boss (e.g. a radially outermost end of the boss relative to the turbine wheel axis and/or flow axis).

The use of a flange to define an engagement surface is advantageous in aligning the dosing module with the dosing module mount. For example, the flange may comprise features, such a recesses and protrusions, which are configured to align the dosing module with the dosing module mount. The use of a flange may also increase the relative ease of engaging the dosing module with the dosing module mount. The incorporation of a flange also facilitates the use of a clamp (e.g. a V-band clamp) to secure the dosing module to the dosing module mount.

The flange may extend around a perimeter of the boss. In particular, the flange may extend around the entire perimeter of the boss. Alternatively, the flange may extend around only a portion of a perimeter of the boss.

The structure which at least partly defines the turbine outlet passage may comprise an opening; and
the dosing module may be configured to inject aftertreatment fluid through the opening.

The term “opening” encompasses a hole, aperture, or orifice. The opening may be considered to provide a fluid pathway between the turbine outlet passage and a region external to the turbine outlet passage. Put another way, the opening may provide fluid communication across the structure defining the turbine outlet passage.

“Injecting aftertreatment fluid through the opening” is intended to mean that at the point which the injected aftertreatment fluid passes through the opening, the aftertreatment fluid is in a state in which it can readily mix with exhaust gas in the turbine outlet passage, without the need to interact with any additional component to promote atomisation of the aftertreatment fluid. As such, the term “inject” refers to expelling the aftertreatment fluid under pressure, such that it is expelled through the opening as a fine spray, or mist, which can readily mix with the exhaust gas in the turbine outlet passage. In contrast, aftertreatment systems which do not inject aftertreatment fluid may first deliver the aftertreatment fluid to a component, for example an atomising cup, which promotes the atomisation of the aftertreatment fluid to facilitate mixing with exhaust gas.

Injecting aftertreatment fluid through the opening advantageously means that the dosing module can be recessed relative to the turbine outlet passage. This reduces disruption to the exhaust gas flow, which may otherwise have a tendency to recirculate in the vicinity of the dosing module.

The dosing module mount may be located within around 5 exducer diameters, along the flow axis, downstream of the downstream end of the turbine wheel.

A centroid of the opening of the dosing module mount may be located within around 5 exducer diameters, along the flow axis, downstream of the downstream end of the turbine wheel

The outlet of the dosing module may be located within around 5 exducer diameters, along the flow axis, downstream of the downstream end of the turbine wheel.

The distance of the dosing module outlet downstream of the downstream end of the turbine wheel may specifically refer to the position of a centroid of the dosing module outlet along the flow axis, when taken at a shortest distance to the flow axis. Because the dosing module outlet is within around 5 exducer diameters of the turbine wheel, the dosing module outlet, and hence the location at which aftertreatment fluid is injected into the turbine outlet passage, is positioned relatively close to the turbine wheel. This ensures that the aftertreatment fluid is injected into relatively high energy exhaust gas flow which has not lost energy to pipe friction, transient heat loss or the like. The exhaust gas flow which is relatively close to the exducer has relatively high swirl which, in turn, creates regions of relatively high turbulent kinetic energy. Injecting the aftertreatment fluid into the exhaust gas where the temperature, energy and swirl of the exhaust gas flow is relatively high promotes the decomposition of the aftertreatment fluid into ammonia and Isocyanic acid to support a downstream SCR reaction. Uniform distribution of the aftertreatment fluid in the exhaust gas flow is also promoted, thereby increasing the efficiency of aftertreatment processes in removing harmful substances from the exhaust gas flow.

Furthermore, providing the outlet of the dosing module within around 5 exducer diameters promotes a compact arrangement (i.e. provides packaging advantages).

The outlet of the dosing module may be provided within around 3 exducer diameters, along the flow axis, downstream of the turbine wheel.

The outlet of the dosing module may be provided within around 3 to 5 exducer diameters, along the flow axis, downstream of the turbine wheel.

The outlet of the dosing module may be provided within around 150 mm, and optionally within around 100 mm, along the flow axis, downstream of the turbine wheel.

The outlet of the dosing module may be provided within around 200 mm, and optionally within around 150 mm, along the flow axis, downstream of the turbine wheel.

Where the turbine wheel is secured to a shaft by a wheel nut, and end face of the wheel nut defines an effective face of the turbine wheel. As such, the outlet of the dosing module may be provided within around 3 exducer diameters, along the flow axis, downstream of an end face of the turbine wheel nut.

The dosing module mount may comprise a first recess; and
at least part of the dosing module may be disposed in the first recess.

The first recess may otherwise be described as a channel in the dosing module mount. The at least part of the dosing module may be considered to be contained within the first recess. The first recess may protect the dosing module from hot exhaust gasses in the turbine outlet passage.

The outlet may be substantially flush with an interior surface of the structure which at least partly defines the turbine outlet passage.

The outlet being substantially flush with an interior surface of the structure is intended to mean that the dosing module does not project into the turbine outlet passage by more than an assembly tolerance (e.g. around ±2 mm).

Advantageously, adverse flow behaviour, owing to an otherwise interrupted interior surface, is reduced.

The turbine outlet passage may at least partly diverge.

The turbine outlet passage at least partly diverging may otherwise be described as the cross sectional area of the turbine outlet passage increasing along the flow axis in a downstream direction (e.g. moving away from the turbine wheel). In other words, the turbine outlet passage may comprise a diffuser. It will be appreciated that the cross sectional area of the passage may increase linearly or non-linearly along its length. Nevertheless, the turbine outlet passage may also comprise one or more portions where the cross-sectional area is constant. For example, the turbine outlet passage may comprise one or more sections of diverging conically shaped walls separated by portions of substantially constant diameter. An entirety of the turbine outlet passage may diverge. The turbine outlet passage may diverge along the flow axis between the downstream end of the turbine wheel and the dosing module mount.

The diffuser may condition the turbine bulk flow of exhaust gas as it travels therethrough. As the cross sectional area of the diffuser increases (i.e. as the walls which define the outlet passage diverge) the velocity of the flow decreases and the pressure increases.

The increase in pressure may be used to increase the efficiency of the turbine and/or an associated exhaust gas aftertreatment system. For example, reducing the velocity of the turbine bulk flow through the turbine outlet passage may allow injected aftertreatment fluid to more readily penetrate the turbine bulk flow in the turbine outlet passage.

The diffuser may be an axial diffuser which extends axially along a geometric centreline. The centreline of the diffuser may be coaxial with the turbine wheel axis. The diffuser may comprise a circular cross-section, which may also be referred to as a conical-wall diffuser. The axial diffuser may be rotationally symmetrical about the centreline.

Flow through an axial diffuser has relatively low energy losses associated with it. This may allow for the kinetic energy to be efficiently converted to provide an increase in static pressure of the flow as it travels through the diffuser.

The dosing module mount may be provided in a diverging portion of the turbine outlet passage.

The dosing module mount being provided in a diverging portion of the turbine outlet passage is intended to mean that the dosing module mount is provided in a region where, immediately upstream of the dosing module mount (i.e. closer to the turbine wheel), the cross sectional area of the turbine outlet passage is smaller than the cross sectional area of the turbine outlet passage downstream of the mount. Described another way, the dosing module mount is located at an axial position along the flow axis whereat the turbine outlet passage is increasing in cross sectional area.

In a diverging portion of the turbine outlet passage, the exhaust gas in the turbine outlet passage is expanding, such that the velocity of the exhaust gas is decreasing and the pressure is increasing. Further, in the diverging portion of the turbine outlet passage the turbulent kinetic energy of the exhaust gas increases. Injecting aftertreatment fluid into a diverging portion of the turbine outlet passage promotes distribution of the aftertreatment fluid throughout the exhaust gas flow due to the velocity of the exhaust gas flow decreasing, and due to the higher turbulent kinetic energy of the exhaust gas (which promotes mixing of the injected aftertreatment fluid with the exhaust gas).

By virtue of the dosing module mount being provided in the diverging portion of the turbine outlet passage, a primary impingement zone, defined by the dosing module, may also be provided at least partially within, optionally entirely within, the diverging portion of the turbine outlet passage.

In other embodiments, the dosing module mount may be provided in a region where the cross sectional area of the turbine outlet passage is constant. In particular, the region of constant cross sectional area may be upstream of a diverging section of the turbine outlet passage.

The dosing module mount may be integral with the structure which at least partly defines the turbine outlet passage.

The dosing module mount and surrounding structure being integral may otherwise be described as the mount and surrounding structure being a unitary structure, or component. The term “surrounding structure” encompasses a wall which at least partly defines the turbine outlet passage.

Providing the dosing module mount and the surrounding structure as an integral structure advantageously removes any joints between the dosing module mount and the structure. Such joints may be prone to failure due to stresses and fatigue around the joint, and/or corrosive substances being deposited at or near the joint, to name just some examples.

Providing the dosing module mount and the surrounding structure as an integral structure also allows the dosing module mount to be located closer to the turbine wheel.

Providing the dosing module mount and the surrounding structure as an integral structure also removes a step in the assembly process whereby the dosing module mount is otherwise joined to the surrounding structure (e.g. by way of welding).

A monoblock turbine housing may define the turbine inlet passage, the turbine wheel chamber and the turbine outlet passage, the monoblock turbine housing comprising the dosing module mount.

Monoblock turbine housing is intended to refer to a turbine housing which is a single, unitary component. For example, there is no separate connection adapter. A monoblock turbine housing may otherwise be described as having a unitary structure. The monoblock turbine housing may comprise a volute, wheel chamber and diffuser. The monoblock turbine housing may be cast as a single, monolithic structure.

Owing to the monoblock turbine housing defining the turbine outlet passage, the dosing module mount is also incorporated in the turbine housing. Put another way, the turbine housing comprises the dosing module mount.

A monoblock turbine housing is advantageous because the number of joints, in which the aftertreatment fluid and/or resulting deposits can settle and risk corrosion to the turbine housing, is reduced or eliminated altogether.

The turbine dosing system may further comprise a turbine housing assembly, the turbine housing assembly comprising:
a turbine housing, the turbine housing defining the turbine inlet passage and the turbine wheel chamber; and
a connection adapter, the connection adapter being coupled to the turbine housing and at least partly defining the turbine outlet passage.

As used herein, a turbine housing assembly is an assembly having at least two parts: a turbine housing (defining the inlet passage and wheel chamber); and a connection adapter (connected to the turbine housing).

The term “connection adapter” refers to a component which is provided between a turbine housing and a downstream conduit. The connection adapter may, for example, interpose a turbine housing and an exhaust manifold or pipe. The connection adapter may engage a turbine housing at one end. The connection adapter may engage a conduit at an opposing end. The connection adapter may comprise the dosing module mount and may be referred to as a dosing connection adapter or a reductant dosing connection adapter, owing to incorporation of the dosing module mount. The connection adapter may be described as structurally integrated with the turbine housing (e.g. connected to the turbine housing using one or more fasteners). This is in contrast to a conduit, which may be connected to a monoblock turbine housing or a connection adapter using, for example, a V-band clamp (e.g. non-structural).

The connection adapter may be a generally frustoconical body. In other arrangements, the connection adapter may be a generally tubular body. The connection adapter may be said to comprise a first end and a second end. A first connection portion may be provided at the first end of the connection adapter. A second connection portion may be provided at the second end of the connection adapter. An outer wall surface of the connection adapter may be a solid surface in that it extends continuously (save for any opening defined by the dosing module mount, where appropriate) between the first and second connection portions. The outer wall advantageously provides a protective, or shielding, functionality in that the outer wall may be the wall that is externally exposed to contaminants and/or damage in use. Put another way, the turbine outlet passage may be shielded by the outer wall.

The connection adapter may define an entirety, or a majority, of the turbine outlet passage. The turbine housing may define at least part of the turbine outlet passage. Alternatively, the turbine housing may not define any of the turbine outlet passage (e.g. the connection adapter may extend from a downstream end of the turbine wheel).

The incorporation of the connection adapter is advantageous because a single design of turbine housing can be used for a range of different applications. That is to say, the connection adapter can be more readily modified for connection to a downstream conduit as dictated by application requirements. As such, rather than providing a range of different turbine housings, which are a complicated geometry to design and manufacture, the connection adapter can be modified depending upon application requirements. A customer can therefore attach their preferred conduit to a downstream end of the connection adapter, whilst using a single design of turbine housing for the turbine. This is also advantageous because the dosing module mount, which may be a customer specific requirement, can be incorporated in the connection adapter, relatively close to the turbine wheel. Furthermore, the connection adapter can be readily attached to the turbine housing, and to a conduit, such that the installation is straightforward.

The connection adapter may comprise the dosing module mount.

The turbine dosing system may comprise a turbine housing element and may further comprise a conduit connected to a downstream end of the turbine housing element, the conduit defining at least part of the turbine outlet passage and comprising the dosing module mount.

The turbine housing element may be a monoblock turbine housing or a connection adapter of a turbine housing assembly.

The conduit may have a generally uniform wall thickness along its extent. The conduit may be described as generally elongate. The conduit may have a constant cross-section downstream of a particular axial point along its extent. Described another way, the conduit may increase in cross-sectional area (e.g. diverge), and then have a constant cross-section beyond that point.

The flow axis through the conduit may comprise a bend, and the dosing module mount may be located upstream of the bend of the flow axis.

Where the conduit comprises the bend, the flow axis changes direction (i.e. by more than around 45 degrees).

Advantageously, the exhaust gas flow has a generally higher energy upstream of the bend. Injecting aftertreatment fluid into the exhaust gas at this position thus provides improved mixing and decomposition of the aftertreatment fluid.

The turbine dosing system may further comprise an exhaust gas sensor.

It is advantageous to provide a sensor which is able to sense real-time properties of an exhaust gas flow in a turbine passage, in particular in a turbine outlet passage. The provision of sensing real-time properties of an exhaust gas flow allows for more accurate control of a turbine and delivery of aftertreatment fluids into an exhaust gas flow. The exhaust gas sensor may be configured to sense the amount of NOx in an exhaust gas flow. Described another way, the exhaust gas sensor may be a NOx sensor.

The exhaust gas sensor may be at least partly disposed within an exhaust gas sensor channel. The exhaust gas sensor channel may be configured to separate an aliquot of exhaust gas from a turbine bulk flow. Said aliquot of exhaust gas may be reduced in velocity and/or pressure in the channel, so as to facilitate the sampling of the exhaust gas by the sensor and reduce the risk of the sensor becoming damaged.

According to a second aspect of the invention there is provided a turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter;
a turbine outlet passage downstream of the turbine wheel chamber and configured to receive exhaust gas from the turbine wheel chamber, the turbine outlet passage being at least partly defined by a structure which comprises a dosing module mount, the turbine outlet passage defining a flow axis which extends from a downstream end of the turbine wheel; and
a dosing module mounted to the dosing module mount and configured to inject aftertreatment fluid, via an outlet of the dosing module, into exhaust gas in the turbine outlet passage;
wherein the dosing module is located within around 10 exducer diameters, along the flow axis, downstream of the downstream end of the turbine wheel.

According to a third aspect of the invention there is provided a turbocharger comprising:
a compressor, the compressor comprising a compressor housing and a compressor wheel;
a bearing housing, the bearing housing being configured to support a shaft for rotation about an axis; and
a turbine dosing system according to any preceding claim;
wherein the compressor wheel and turbine wheel are coupled to the shaft in power communication with one another.

According to a fourth aspect of the invention there is provided an engine arrangement comprising;
an engine; and
a turbocharger according to the third aspect of the invention;
wherein the turbocharger is configured to receive exhaust gas from the engine.

According to a fifth aspect of the invention there is provided a monoblock turbine housing for a turbine dosing system, the turbine housing comprising:
a turbine inlet passage configured to receive exhaust gas from an internal combustion engine;
a turbine wheel chamber configured to receive exhaust gas from the turbine inlet passage, the turbine wheel chamber configured to receive a turbine wheel;
a turbine housing outlet passage downstream of the turbine wheel chamber and in fluid communication with the turbine wheel chamber; and
a dosing module mount, downstream of the turbine wheel chamber, the dosing module mount being configured to receive a dosing module, the dosing module mount being in communication with the turbine housing outlet passage via an opening, defined in the turbine housing, through which aftertreatment fluid is injectable into exhaust gas in the turbine housing outlet passage.

The monoblock turbine housing may be for a turbocharger dosing system. That is, the monoblock turbine housing may form part of a turbine dosing system for, or of, a turbocharger. The monoblock turbine housing may be configured to engage a bearing housing. The bearing housing may interpose the monoblock turbine housing and a compressor housing.

At least a portion of the turbine housing outlet passage may diverge. The dosing module mount may be disposed at the diverging portion of the turbine housing outlet passage. The diverging portion of the turbine housing outlet passage may define at least part of a turbine outlet passage.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel.

The term “opening” encompasses a hole, aperture, or orifice. The opening may be considered to provide a fluid pathway between the turbine housing outlet passage and a region external to the turbine housing outlet passage. Put another way, the opening may provide fluid communication across, or through, the monoblock turbine housing. The opening may be a through bore. The opening may be provided at a single circumferential position. The monoblock turbine housing may comprise a single dosing mount defining a single opening. The opening may define the only fluid pathway between the dosing module and the turbine housing passage outlet passage. The opening is preferably located entirely downstream of the turbine wheel and turbine wheel chamber.

“Injecting aftertreatment fluid through the opening” is intended to mean that at the point which the injected aftertreatment fluid passes through the opening, the aftertreatment fluid is in a state in which it can readily mix with exhaust gas in the turbine outlet passage, without the need to interact with any additional component to promote atomisation of the aftertreatment fluid. As such, the term “inject” refers to expelling the aftertreatment fluid under pressure, such that it is expelled through the opening as a fine spray, or mist, which can readily mix with the exhaust gas in the turbine housing outlet passage. In contrast, aftertreatment systems which do not inject aftertreatment fluid may first deliver the aftertreatment fluid to a component, for example an atomising cup, which promotes the atomisation of the aftertreatment fluid to facilitate mixing with exhaust gas.

The dosing module mount, and dosing module where appropriate, preferably points in (e.g. is angled in) a downstream direction (i.e. towards an outlet of the monoblock turbine housing and away from the turbine wheel chamber). The downstream direction is defined with respect to a flow axis defined by the turbine housing outlet passage. In other embodiments, the dosing module mount, and dosing module where appropriate, may be orthogonal with respect to the flow axis, or may point (e.g. be angled in) an upstream direction with respect to the flow axis (i.e. towards the turbine wheel chamber and away from the outlet of the monoblock turbine housing). A primary impingement zone defined by the dosing module is preferably entirely downstream of the turbine wheel chamber.

An outlet of the dosing module may be substantially flush with an interior surface of the monoblock turbine housing. The outlet being substantially flush with the interior surface of the housing is intended to mean that the dosing module does not project into the turbine housing outlet passage by more than an assembly tolerance (e.g. around ±2 mm). The interior surface of the monoblock turbine housing, surrounding the opening of the dosing module mount, is preferably substantially continuous (e.g. the dosing module mount preferably does not define a dogleg or recess). The dosing module preferably does not project into the turbine housing outlet passage.

The dosing module and/or dosing module mount may be located within around 10 exducer diameters, around 7 exducer diameters, around 5 exducer diameters, and around 3 exducer diameters downstream of the downstream end of the turbine wheel or turbine wheel chamber. The dosing module may be located at least around 1 exducer diameter downstream of the downstream end of the turbine wheel or turbine wheel chamber. The dosing module is preferably located between around 1 exducer diameter, and around 3 exducer diameters, downstream of the downstream end of the turbine wheel or turbine wheel chamber.

The monoblock turbine housing may comprise a wastegate arrangement. The wastegate arrangement may comprise a valve assembly and a wastegate passage. The wastegate passage may extend between the turbine inlet passage and the turbine housing outlet passage, around the turbine wheel and turbine wheel chamber.

The monoblock turbine housing may be a single skin arrangement insofar as the turbine housing outlet passage is defined by a single wall.

According to a sixth aspect of the invention there is provided a connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit;
a structure which extends between the first and second ends of the connection adapter and defines a connection adapter passage configured to receive exhaust gas from a turbine housing, the structure comprising a dosing module mount, the dosing module mount being configured to receive a dosing module, the dosing module mount being in communication with the connection adapter passage via an opening, defined in the structure, through which aftertreatment fluid is injectable into exhaust gas in the connection adapter passage.

The connection adapter may be described as structurally integrated with a turbine housing (e.g. connected to the turbine housing using one or more fasteners). The connection adapter is preferably provided directly downstream of the turbine housing. Exhaust gas may be described as passing through the turbine housing and then through the connection adapter. The connection adapter may be described as being disposed downstream of the turbine hosing, specifically an outlet thereof.

The dosing module mount is preferably provided at a position along the connection adapter passage where the connection adapter passage diverges (e.g. a diffuser portion). Such a diverging portion may be said to define a diffuser of the turbine. The dosing module mount and/or dosing module may be provided at a linear portion of the connection adapter (e.g. where the connection adapter extends in a straight, non-bent manner).

One or more of the first and second connection portions may comprise a flange.

The connection adapter may be for a turbocharger dosing system. That is, the connection adapter may form part of a turbine housing assembly of a turbine dosing system for, or of, a turbocharger.

At least a portion of the connection adapter passage may diverge. The dosing module mount may be disposed at the diverging portion of the connection adapter passage. The diverging portion of the connection adapter passage may define at least part of a turbine outlet passage. The entirety of the connection adapter passage may diverge. The connection adapter may define a diffuser, or at least part of a diffuser, of a turbine housing assembly.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel. The dosing module is preferably an externally attachable module.

The term “opening” encompasses a hole, aperture, or orifice. The opening may be considered to provide a fluid pathway between the connection adapter passage and a region external to the connection adapter passage. Put another way, the opening may provide fluid communication across, or through, the connection adapter. The opening may be a through bore. The opening may be provided at a single circumferential position. The connection adapter may comprise a single dosing mount defining a single opening. The opening may define the only fluid pathway between the dosing module and the connection adapter passage. The opening is preferably located entirely downstream of the turbine wheel and turbine wheel chamber.

“Injecting aftertreatment fluid through the opening” is intended to mean that at the point which the injected aftertreatment fluid passes through the opening, the aftertreatment fluid is in a state in which it can readily mix with exhaust gas in the connection adapter passage, without the need to interact with any additional component to promote atomisation of the aftertreatment fluid. As such, the term “inject” refers to expelling the aftertreatment fluid under pressure, such that it is expelled through the opening as a fine spray, or mist, which can readily mix with the exhaust gas in the connection adapter passage. In contrast, aftertreatment systems which do not inject aftertreatment fluid may first deliver the aftertreatment fluid to a component, for example an atomising cup, which promotes the atomisation of the aftertreatment fluid to facilitate mixing with exhaust gas.

The dosing module mount, and dosing module where appropriate, preferably points in (e.g. is angled in) a downstream direction (i.e. towards an outlet of the connection adapter and away from the inlet). The downstream direction is defined with respect to a flow axis defined by the connection adapter passage. In other embodiments, the dosing module mount, and dosing module where appropriate, may be orthogonal with respect to the flow axis, or may point (e.g. be angled in) an upstream direction with respect to the flow axis (i.e. towards the inlet and away from the outlet of the connection adapter). A primary impingement zone defined by the dosing module is preferably entirely downstream of the turbine wheel chamber. The primary impingement zone may be entirely contained by the connection adapter passage.

An outlet of the dosing module may be substantially flush with an interior surface of the connection adapter. The outlet being substantially flush with the interior surface of the connection adapter is intended to mean that the dosing module does not project into the turbine housing outlet passage by more than an assembly tolerance (e.g. around ±2 mm). The interior surface of the connection adapter, surrounding the opening of the dosing module mount, is preferably substantially continuous (e.g. the dosing module mount preferably does not define a dogleg or recess). The dosing module preferably does not project into the connection adapter passage.

The dosing module and/or dosing module mount may be located within around 10 exducer diameters, around 7 exducer diameters, around 5 exducer diameters, and around 3 exducer diameters downstream of the downstream end of a turbine wheel or turbine wheel chamber. The dosing module may be located at least around 1 exducer diameter downstream of the downstream end of the turbine wheel or turbine wheel chamber. The dosing module is preferably located between around 1 exducer diameter, and around 3 exducer diameters, downstream of the downstream end of the turbine wheel or turbine wheel chamber.

The connection adapter may comprise at least part of a wastegate arrangement. The wastegate arrangement may comprise a valve assembly and a wastegate passage. The wastegate passage may extend between a turbine inlet passage and the connection adapter passage, around the turbine wheel and turbine wheel chamber. The connection adapter may comprise at least part of the wastegate passage. The connection adapter may comprise a wastegate passage outlet, where the wastegate passage connects to the connection adapter passage.

The connection adapter may be a single skin arrangement insofar as the connection adapter outlet passage is defined by a single wall. The connection adapter may be described as a conduit or tube.

Exhaust gas is preferably unobstructed through, or across, the connection adapter. Described another way, a cross-section of the connection adapter, normal to a flow axis, is substantially, or entirely, free of any components (e.g. mixers) which create a pressure drop across the flow.

According to a seventh aspect of the invention there is provided an aftertreatment fluid dosing conduit for a turbine dosing system, the conduit comprising:
a first connection portion, at a first end of the conduit, configured to engage a turbine housing element;
a structure which extends from the first end of the conduit and defines a conduit passage configured to receive exhaust gas from the turbine housing element, the structure comprising a dosing module mount configured to receive a dosing module, the dosing module mount being in communication with the conduit passage via an opening, defined in the structure, through which aftertreatment fluid is injectable into exhaust gas in the conduit passage.

The conduit may have a generally uniform wall thickness along its extent. The conduit may be described as generally elongate. The conduit may have a constant cross-section downstream of a particular axial point along its extent. Described another way, the conduit may increase in cross-sectional area (e.g. diverge), and then have a constant cross-section beyond that point.

The dosing module mount is preferably provided at a position along the conduit passage where the conduit passage diverges (e.g. a diffuser portion). Such a diverging portion may be said to define a diffuser of the turbine.

The first connection portion may comprise a flange.

At least a portion of the conduit passage may diverge. The dosing module mount may be disposed at the diverging portion of the conduit passage. The diverging portion of the conduit passage may define at least part of a turbine outlet passage. The entirety of the conduit passage may diverge. The conduit passage may define a diffuser, or at least part of a diffuser, of a turbine.

The dosing module may be a self-atomising dosing module. As would be apparent to the skilled person, dosing modules for use in exhaust gas aftertreatment systems are available in self-atomising and non-self-atomising types. As used herein a “self-atomising” dosing module encompasses a dosing module which is configured to create a fine spray or mist of aftertreatment fluid emanating from the outlet of the dosing module, this may be achieved by mixing compressed air with the aftertreatment liquid. By contrast, a “non-self-atomising” dosing module encompasses a dosing module which introduces a homogenous stream of aftertreatment fluid (mainly liquid) that becomes atomised following impingement with a moving object, for example a rotating cup mounted to the turbine wheel. The dosing module is preferably an externally attachable module.

The term “opening” encompasses a hole, aperture, or orifice. The opening may be considered to provide a fluid pathway between the conduit passage and a region external to the conduit passage. Put another way, the opening may provide fluid communication across, or through, the aftertreatment fluid dosing conduit. The opening may be a through bore. The opening may be provided at a single circumferential position. The connection adapter may comprise a single dosing mount defining a single opening. The opening may define the only fluid pathway between the dosing module and the conduit passage. The opening is preferably located entirely downstream of the turbine wheel and turbine wheel chamber.

“Injecting aftertreatment fluid through the opening” is intended to mean that at the point which the injected aftertreatment fluid passes through the opening, the aftertreatment fluid is in a state in which it can readily mix with exhaust gas in the conduit passage, without the need to interact with any additional component to promote atomisation of the aftertreatment fluid. As such, the term “inject” refers to expelling the aftertreatment fluid under pressure, such that it is expelled through the opening as a fine spray, or mist, which can readily mix with the exhaust gas in the conduit passage. In contrast, aftertreatment systems which do not inject aftertreatment fluid may first deliver the aftertreatment fluid to a component, for example an atomising cup, which promotes the atomisation of the aftertreatment fluid to facilitate mixing with exhaust gas.

The dosing module mount, and dosing module where appropriate, preferably points in (e.g. is angled in) a downstream direction (i.e. towards an outlet of the conduit and away from the inlet/first connection portion). The downstream direction is defined with respect to a flow axis defined by the conduit passage. In other embodiments, the dosing module mount, and dosing module where appropriate, may be orthogonal with respect to the flow axis, or may point (e.g. be angled in) an upstream direction with respect to the flow axis (i.e. towards the inlet/first connection portion and away from the outlet of the conduit). A primary impingement zone defined by the dosing module is preferably entirely downstream of the turbine wheel chamber. The primary impingement zone may be entirely contained by the conduit.

An outlet of the dosing module may be substantially flush with an interior surface of the conduit. The outlet being substantially flush with the interior surface of the conduit is intended to mean that the dosing module does not project into the conduit passage by more than an assembly tolerance (e.g. around ±2 mm). The interior surface of the conduit, surrounding the opening of the dosing module mount, is preferably substantially continuous (e.g. the dosing module mount preferably does not define a dogleg or recess). The dosing module preferably does not project into the conduit passage.

The dosing module and/or dosing module mount may be located within around 10 exducer diameters, around 7 exducer diameters, around 5 exducer diameters, and around 3 exducer diameters downstream of the downstream end of a turbine wheel or turbine wheel chamber. The dosing module may be located at least around 1 exducer diameter downstream of the downstream end of the turbine wheel or turbine wheel chamber. The dosing module is preferably located between around 1 exducer diameter, and around 3 exducer diameters, downstream of the downstream end of the turbine wheel or turbine wheel chamber. The dosing module and/or mount is preferably located upstream of any aftertreatment components (e.g. catalysts). Described another way, any (e.g. all) aftertreatment components (e.g. catalysts) are preferably downstream of the conduit.

The conduit may comprise at least part of a wastegate arrangement. The wastegate arrangement may comprise a valve assembly and a wastegate passage. The wastegate passage may extend between a turbine inlet passage and the conduit passage, around the turbine wheel and turbine wheel chamber. The conduit may comprise at least part of the wastegate passage. The conduit may comprise a wastegate passage outlet, where the wastegate passage connects to the conduit passage.

The conduit may be a single skin arrangement insofar as the conduit passage is defined by a single wall.

Exhaust gas is preferably unobstructed through, or across, the conduit passage. Described another way, a cross-section of the conduit, normal to a flow axis, is substantially, or entirely, free of any components (e.g. mixers) which create a pressure drop across the flow.

According to an eighth aspect of the invention there is provided a method of assembling the turbine dosing system according to the first or second aspects of the invention, the method comprising:
urging the dosing module into engagement with the dosing module mount; and
securing the dosing module to the dosing module mount.

Securing the dosing module to the dosing module mount may comprise placing, and tightening, a clamp around flanges of the dosing module and the dosing module mount.

According to a ninth aspect of the invention there is provided a method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter; and
receiving exhaust gas from the turbine wheel chamber into a turbine outlet passage downstream of the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 10 exducer diameters, along the flow axis, downstream of the downstream end of the turbine wheel.

The method may further comprise a dosing module mounted to the dosing module mount, wherein the dosing module mount injects aftertreatment fluid, via an outlet of the dosing module, into exhaust gas in the turbine outlet passage.

The dosing module mount may comprises an engagement surface; and
the dosing module may engage the engagement surface.

The dosing module mount may comprise a boss.

The boss may comprise a flange, and a face of the flange may defines the engagement surface.

The structure which at least partly defines the turbine outlet passage may comprise an opening; and
the dosing module may injects aftertreatment fluid through the opening.

The dosing module mount may be located within around 5 exducer diameters, along the flow axis, downstream of the downstream end of the turbine wheel.

The dosing module mount may comprise a first recess; and
at least part of the dosing module may be disposed in the first recess.

The outlet may be substantially flush with an interior surface of the structure which at least partly defines the turbine outlet passage.

The turbine outlet passage may at least partly diverge.

The dosing module mount may be provided in a diverging portion of the turbine outlet passage.

The dosing module mount may be integral with the structure which at least partly defines the turbine outlet passage.

A monoblock turbine housing may defines the turbine inlet passage, the turbine wheel chamber and the turbine outlet passage, the monoblock turbine housing comprising the dosing module mount.

The turbine dosing system may further comprise a turbine housing assembly, the turbine housing assembly comprising:
a turbine housing, the turbine housing defining the turbine inlet passage and the turbine wheel chamber; and
a connection adapter, the connection adapter being coupled to the turbine housing and at least partly defining the turbine outlet passage.

The connection adapter may comprise the dosing module mount.

The turbine dosing system may comprise a turbine housing element and further comprise a conduit connected to a downstream end of the turbine housing element, the conduit defining at least part of the turbine outlet passage and comprising the dosing module mount.

The flow axis through the conduit may comprise a bend, and the dosing module mount may be located upstream of the bend of the flow axis.

The method may further comprise sensing one or more properties of exhaust gas using an exhaust gas sensor.

The optional and/or preferred features for each aspect of the invention set out herein are also applicable to any other aspects of the invention.

Specific embodiments of the present invention will now be described, by way of example only, with reference to the accompanying drawings in which:

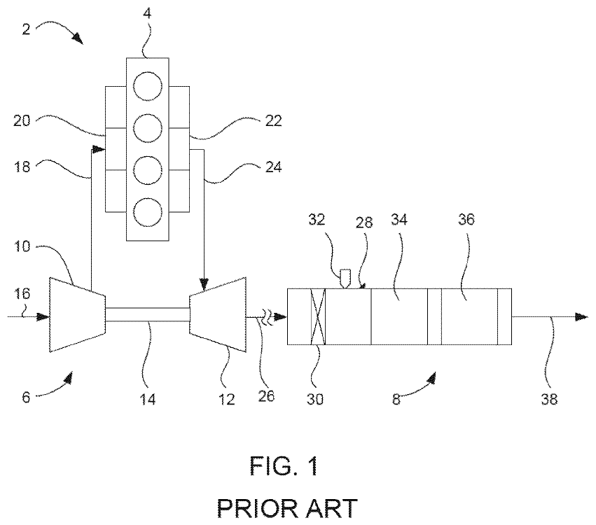

FIG. 1 is a schematic view of a known turbocharged diesel engine system;

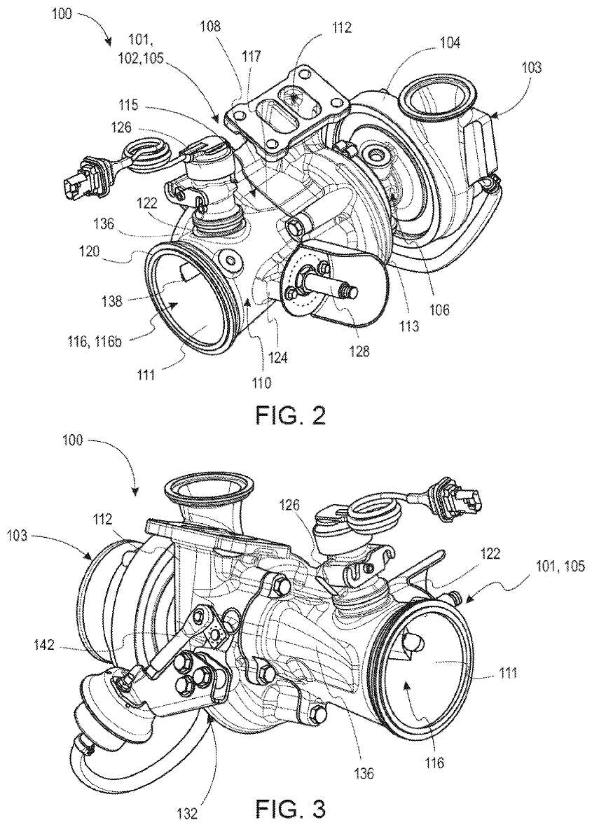

FIG. 2 is a perspective view, generally from above, of a turbocharger comprising a turbine dosing system according to an embodiment of the invention;

FIG. 3 is an alternative perspective view of the turbocharger of FIG. 2;

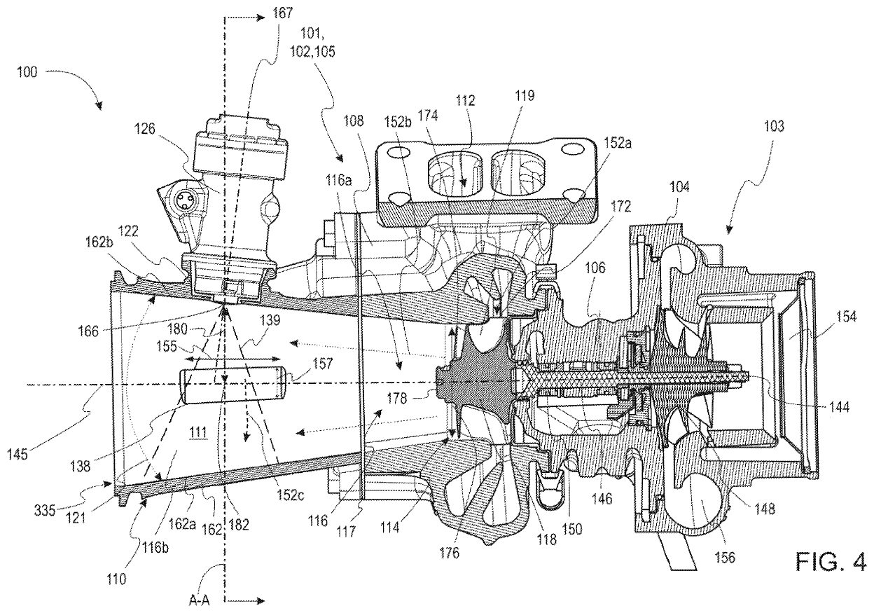

FIG. 4 is a side cross-sectional view of the turbocharger of FIGS. 2 and 3;

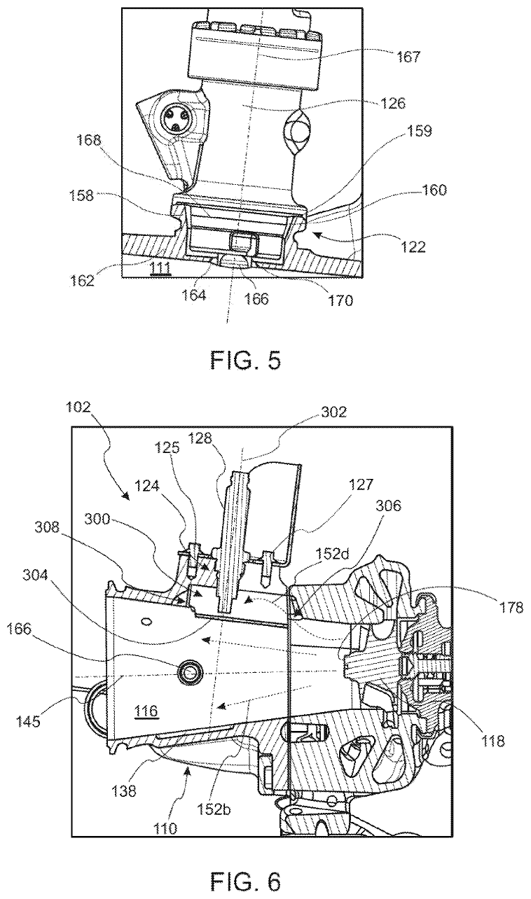

FIG. 5 is an enlarged view of a dosing module, and dosing module mount, of the turbocharger of FIGS. 2 to 4;

FIG. 6 is a side cross-sectional view of the turbocharger, shown in FIGS. 2 to 5, through an alternative plane to the cross-sectional view of FIG. 4;

FIG. 7 is an end view of the turbocharger of FIGS. 2 to 6;

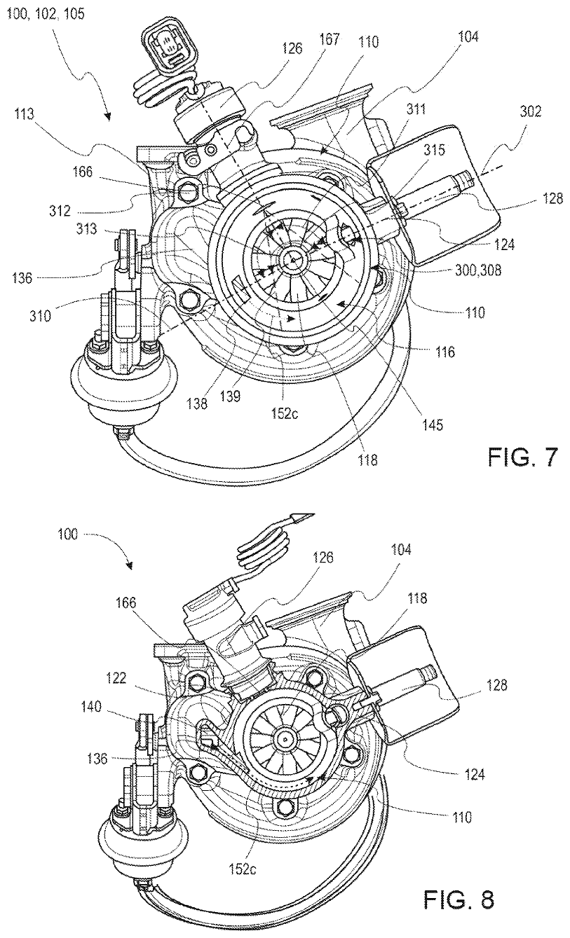

FIG. 8 is a cross-sectional end view of the turbocharger of FIGS. 2 to 7, taken through the plane A-A of FIG. 4;

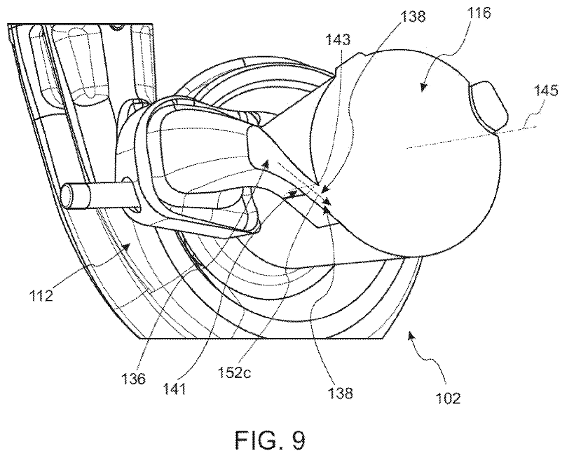

FIG. 9 is a perspective cross-sectional view of an effective cavity of part of the turbine dosing system forming part of the turbocharger shown in FIGS. 2 to 8;

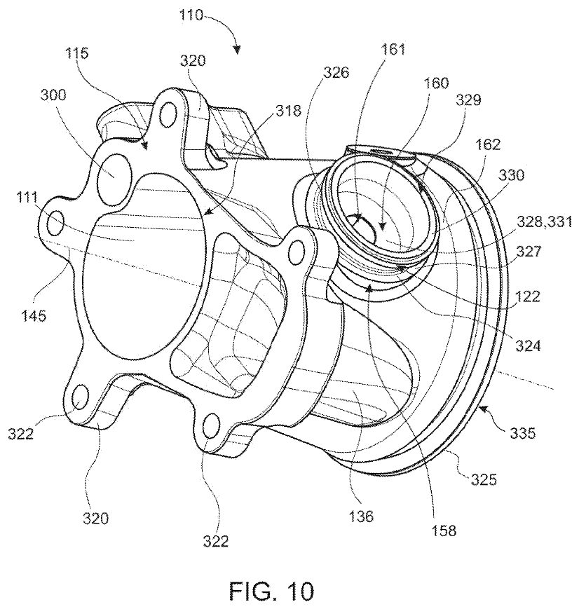

FIG. 10 is a perspective view of a connection adapter, of the turbocharger shown in FIGS. 2 to 9, in isolation;

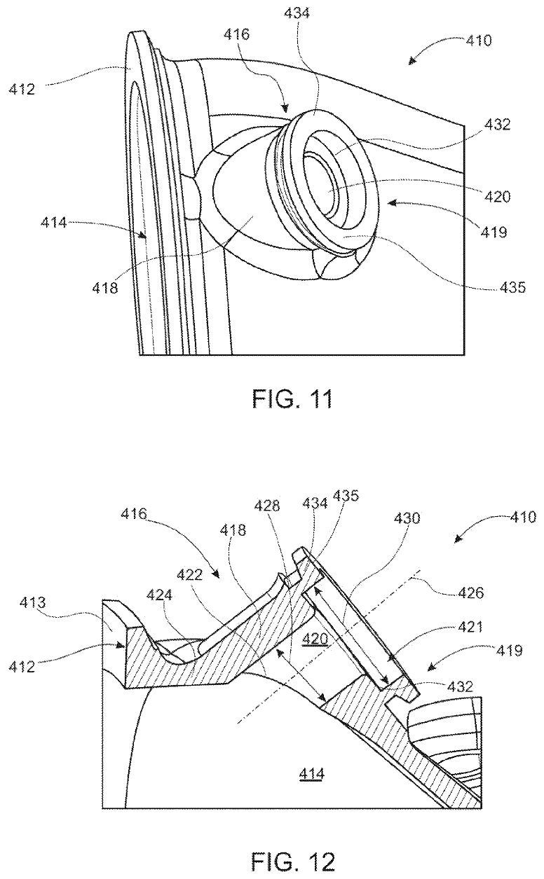

FIG. 11 is a perspective view of part of a connection adapter according to another embodiment;

FIG. 12 is a perspective cross-sectional view, generally from the side, of the part of the connection adapter of FIG. 11;

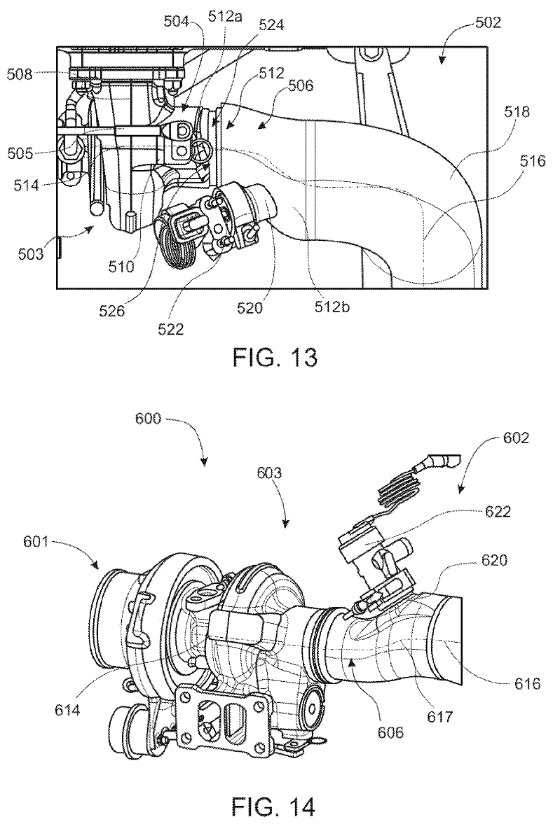

FIG. 13 is a side view of a turbine dosing system according to another embodiment;

FIG. 14 is a perspective view of a turbocharger comprising a turbine dosing system according to another embodiment;

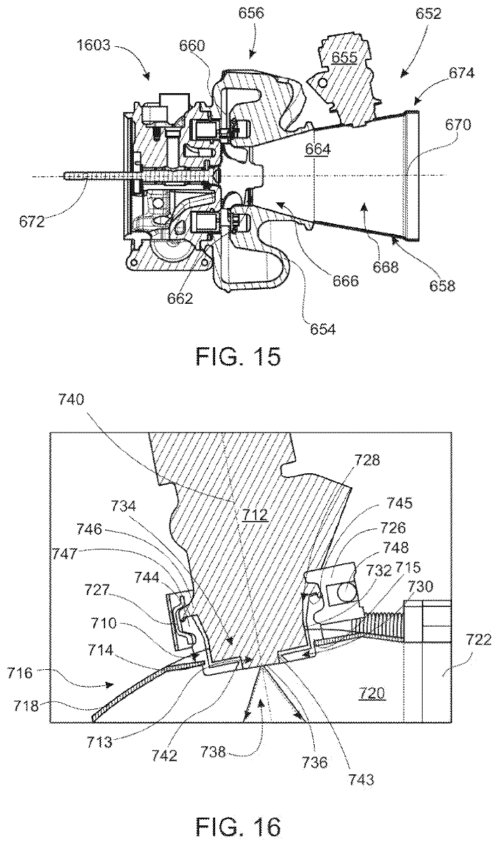

FIG. 15 is a cross-sectional side view of part of a turbocharger incorporating a turbine dosing system according to another embodiment;

FIG. 16 is an enlarged view of a dosing module, dosing module mount and surrounding structure, according to another embodiment;

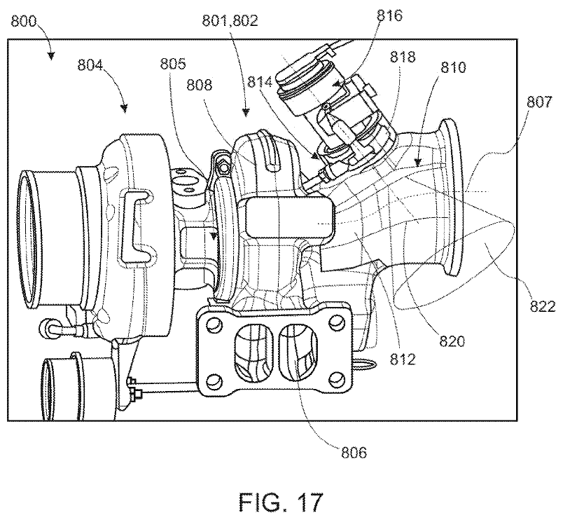

FIG. 17 is a perspective view of a turbocharger comprising a turbine dosing system according to another embodiment;

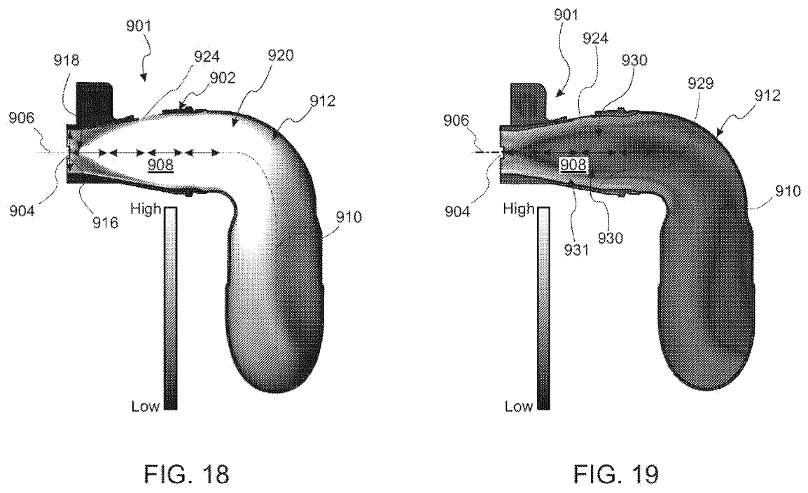

FIG. 18 shows results of a CFD simulation conducted on a turbine dosing system, according to another embodiment, illustrating exhaust gas turbulent kinetic energy variation downstream of the turbine wheel;

FIG. 19 shows exhaust gas velocity variation, downstream of the turbine wheel, in the CFD simulation also shown in FIG. 18;

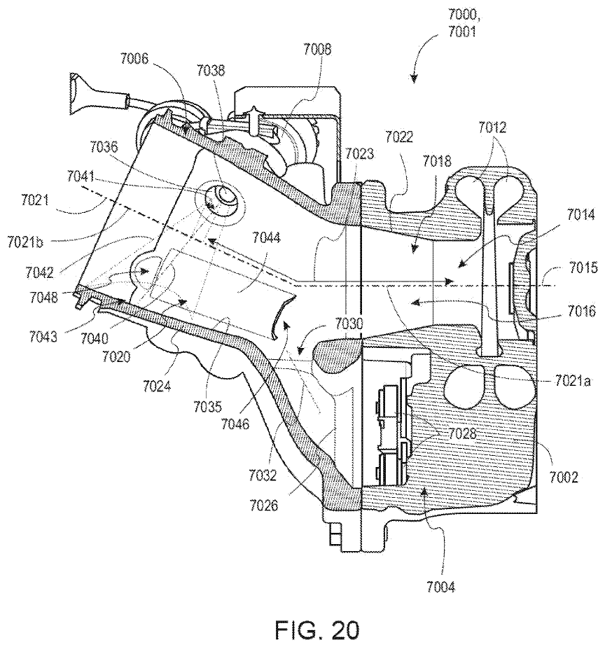

FIG. 20 is a cross-section side view of a turbine dosing system in accordance with one or more aspects of the present invention;

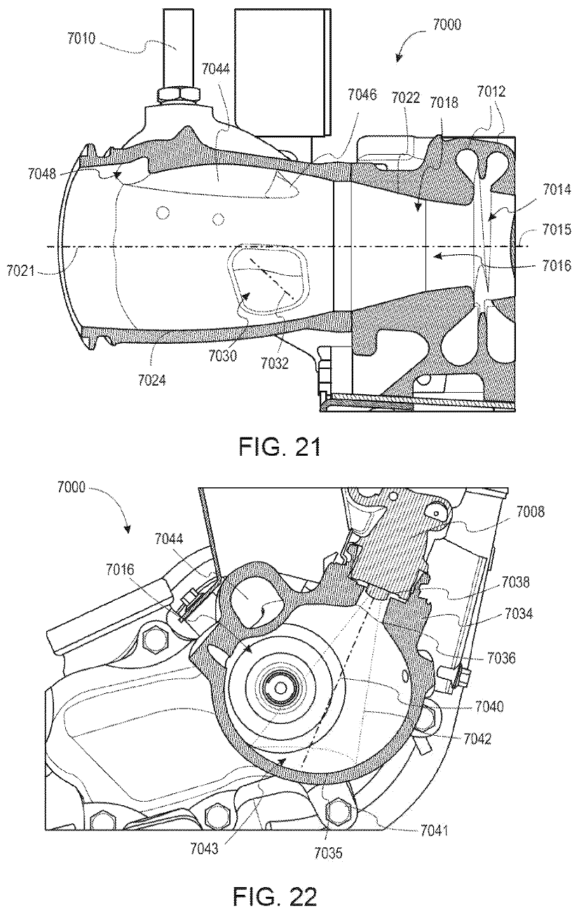

FIG. 21 is a cross-section plan view of the turbine dosing system of FIG. 20;

FIG. 22 is a cross-section end view of the turbine dosing system of FIGS. 20 and 21 taken through the axial position of the dosing module;

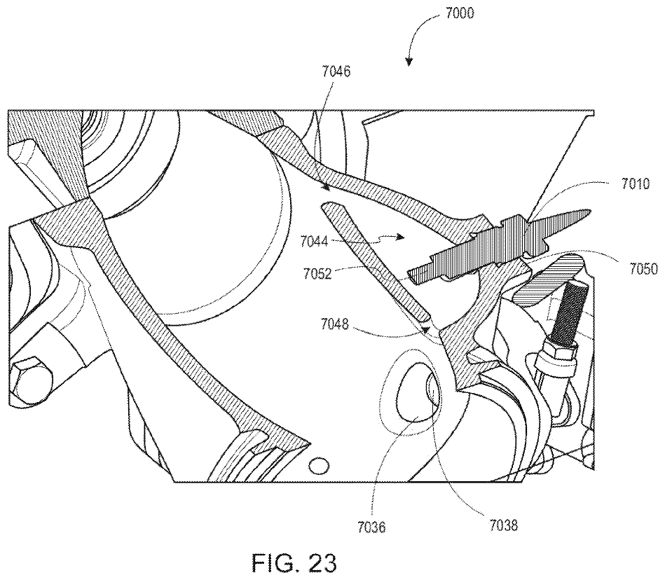

FIG. 23 is a cross-section side view of the turbine dosing system of FIGS. 20 to 22 taken through the sensing passage;

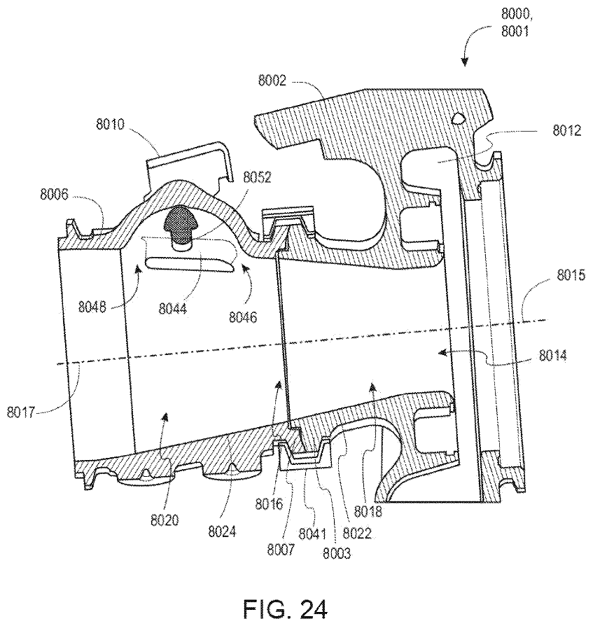

FIG. 24 is a cross-section side view of a turbine dosing system in accordance with one or more aspects of the present invention; and

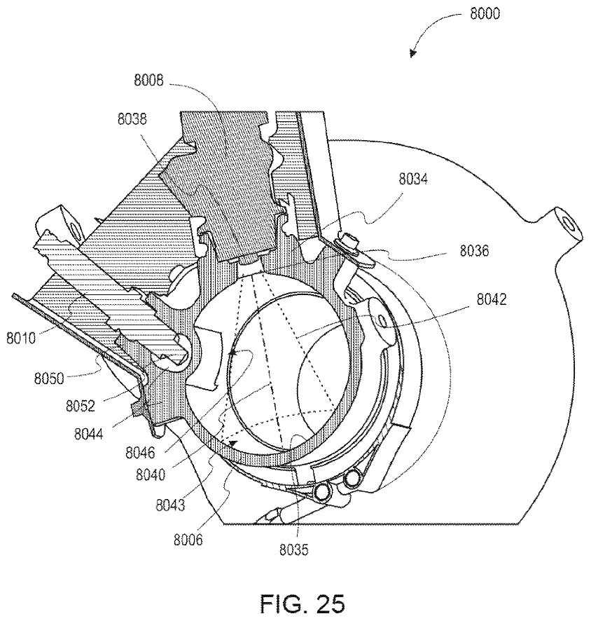

FIG. 25 is a cross-section end view of the turbine dosing system of FIG. 24 taken through the axial position of the dosing module and sensing passage and;

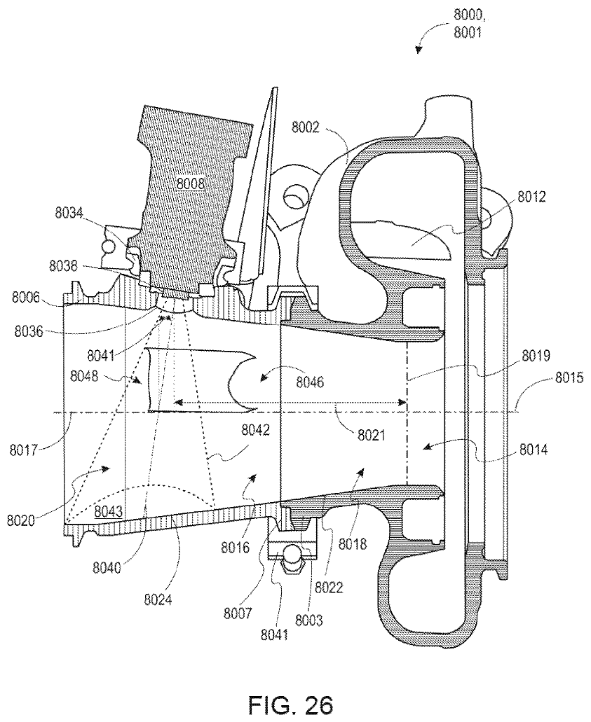

FIG. 26 is an alternative cross-section side view to that shown in FIG. 24.

FIG. 1 is a schematic view of a known turbocharged diesel engine system 2. The system 2 comprises a diesel internal combustion engine 4, a turbocharger 6 and an exhaust gas aftertreatment system 8.

The turbocharger 6 comprises a compressor 10, and a turbine 12, each comprising a respective one of a compressor wheel and turbine wheel. The compressor wheel and turbine wheel are mounted to a common turbocharger shaft 14 such that they rotate in unison.

The compressor 10 receives intake air from a low pressure intake duct 16 connected to atmosphere. The low pressure intake duct 16 may comprise a particulate filter to clean the intake air. The compressor 10 compresses the intake air using power provided by the turbine 12 (via the turbocharger shaft 14) and supplies the compressed intake air to the engine 4 via a high pressure intake duct 18 and an intake manifold 20. Although not shown, the high pressure intake duct 18 may comprise an intercooler configured to cool the intake air before it reaches the engine 4.

Inside the engine 4, an internal combustion process takes place and useful work is produced. As a result of the internal combustion process, exhaust gases are created by the engine 4. The engine 4 is fluidly connected to an exhaust manifold 22 which is, in turn, connected to the turbine 12 via a high pressure exhaust gas duct 24. The turbine 12 (specifically the turbine wheel thereof) extracts energy from the exhaust gas to drive the turbocharger shaft 14 and thereby power the compressor 10. Exhaust gas leaving the turbocharger 12 is supplied to the exhaust gas aftertreatment system 8 via a downpipe 26. The downpipe 26 is relatively long in extent, for example at least 2 metres in length, as indicated by the broken line in FIG. 1.

The exhaust gas aftertreatment system 8 comprises a decomposition chamber 28 having a diameter larger than that of the downpipe 26. The decomposition chamber 28 comprises a mixing element 30 disposed therein. The mixing element 30 typically comprises a number of baffles configured to deflect the flow through the decomposition chamber 28 to cause turbulence within the decomposition chamber 28. The exhaust gas aftertreatment system 8 comprises a dosing module 32 configured to inject an exhaust gas aftertreatment fluid, and specifically Diesel Exhaust Fluid (DEF), into the decomposition chamber 28 downstream of the mixing element 30 in the region where the exhaust gas is most turbulent. Heat exchange between the DEF and the exhaust gas within the decomposition chamber 28 causes the urea contained within the DEF to decompose into the reductants ammonia (NH₃) and Isocyanic Acid (HNCO). The mixture of reductants and exhaust gas is then passed to a selective catalytic reducer (SCR) 34 and a diesel oxidation catalyst (DOC) 36. Finally, the exhaust gas is passed to an outlet duct 38 and onwards to a muffler (not shown) before being discharged to atmosphere.

FIG. 2 is a perspective view of a turbocharger 100, generally from above, comprising a turbine dosing system 105 according to an embodiment of the present invention. The turbocharger 100 comprises a turbine 101 and a compressor 103 interconnected by a bearing housing 106.

In the illustrated embodiment, the turbine 101 forms part of the turbine dosing system 105. This is owing to the incorporation of a dosing module 126. This will be described in greater detail later in this document.

The turbine 101, and so turbine dosing system 105 more generally, comprises a turbine housing assembly 102. The turbine housing assembly 102 comprises a turbine housing 108 and a connection adapter 110. The turbine housing assembly 102 differs from, for example a monoblock turbine housing (see, for example, FIG. 17), owing to the multi-part assembly of the turbine housing 108 and the connection adapter 110 (in comparison to the single-piece turbine housing construction of a monoblock turbine housing). The turbine housing 108 is the part of the turbine housing assembly 102 proximate the bearing housing 106. The turbine housing 108 is configured to engage the bearing housing 106. The connection adapter 110 is separated from the bearing housing 106 by at least an extent of the turbine housing 108. Described another way, the connection adapter 110 is provided downstream of the turbine housing 108.

In the illustrated embodiment, the turbine housing 108 defines a turbine inlet passage 112, a turbine wheel chamber (not visible in FIG. 2) and part of a turbine outlet passage 116. In particular, the turbine housing 108 defines an upstream portion (not visible in FIG. 2) of the turbine outlet passage 116. The turbine inlet passage 112 is defined by a volute 113 (which may otherwise be referred to as a scroll) and is configured to receive exhaust gas from an internal combustion engine (not shown). The volute 113 is thus the structure which defines the turbine inlet passage 112. The turbine inlet passage 112 encourages swirling of the exhaust gas about a turbine wheel axis (not shown in FIG. 2 but labelled 144 in FIG. 4). Described another way, the turbine inlet passage 112 geometry encourages swirl of the exhaust gas flow upstream of a turbine wheel (not visible in FIG. 2 but labelled 118 in FIG. 4). In some embodiments the turbine inlet passage 112 may also impart an axial component to the exhaust gas flow (but not in the illustrated embodiment). The turbine inlet passage 112 may be described as extending in at least in a circumferential and a radial direction about the turbine wheel axis. The swirl of the exhaust gas is changed as the exhaust gas is expanded across the turbine wheel, and may even be reversed depending upon flow conditions and surrounding geometry.

As shown in FIG. 4, the turbine wheel chamber 114 houses a turbine wheel 118. The turbine wheel 118 is configured to rotate about a turbine wheel axis 144. The turbine inlet passage 112 is in fluid communication with the turbine wheel chamber 114. The turbine wheel chamber 114 is in fluid communication with the turbine outlet passage 116.

In use, exhaust gas passes through the turbine inlet passage 112 and into the turbine wheel chamber 114. The exhaust gas is then expanded across the turbine wheel 118 (i.e. does work on the turbine wheel 118) which, in turn, drives rotation of the turbine wheel 118 about the turbine wheel axis 144. As exhaust gas passes over the turbine wheel 118, the magnitude of swirl and/or swirl direction of the exhaust gas changes. The turbine wheel 118 is a radial turbine wheel in that exhaust gas flow from the turbine inlet passage 112 impinges the turbine wheel 118 in a generally radial direction relative to the turbine wheel axis, and exits the turbine wheel 118 in a generally axial direction relative to the turbine wheel axis 144. As the exhaust gas exits the turbine wheel 118, and leaves the wheel chamber 114, it passes into the upstream portion 116a of the turbine outlet passage 116. In other embodiments, the turbine may be an axial turbine, whereby exhaust gas enters a turbine wheel in a generally axial direction and leaves the turbine wheel in a generally axial direction.

Returning to FIG. 2, the connection adapter 110 defines a downstream portion 116b of the turbine outlet passage 116. Said downstream portion 116b may be referred to as a connection adapter passage. A first end 115 of the connection adapter 110 engages the turbine housing 108 (via an interposing gasket 117). The downstream portion 116b of the turbine outlet passage 116, which is defined by the connection adapter 110, is thus in fluid communication with the upstream portion 116a of the turbine outlet passage 116 (defined by the turbine housing 108 and not visible in FIG. 2, but shown in FIG. 4). It will be appreciated that the interposing gasket 117 is an optional feature and an interposing gasket 117 may not be present in other embodiments.

In the illustrated embodiment (and as will be appreciated from FIG. 4) the connection adapter 110 defines a diffuser (e.g. a diverging portion of the turbine outlet passage 116). Exhaust gas thus expands as it passes through the connection adapter 110. The connection adapter 110 may therefore be said to define a diffuser cone, outlet diffuser or turbine stage outlet diffuser. Described another way, the connection adapter 110 defines at least part of a diffuser of the turbine 102, and optionally an entirety of a diffuser of the turbine 102.

The connection adapter 110 comprises a generally tapered interior surface 111 (e.g. a conical wall), whereat the cross sectional area of the interior of the connection adapter 110 increases, from the first end 115 to an opposing second end 120, along an axial extent of the connection adapter 110. The cross sectional area of the turbine outlet passage 116 may thus be said to diverge along the connection adapter 110. The second end 120 is the end of the connection adapter 110 which is furthest away from the turbine housing 108. The increasing cross sectional area defines a diffuser. As exhaust gas travels through the connection adapter 110, from the first end 115 to the second end 120, the velocity of the exhaust decreases, and the total static pressure of the exhaust gas increases, owing to the cross sectional area of the turbine outlet passage 116 increasing. Increasing the total static pressure of the exhaust gas in the connection adapter 110 increases the efficiency of the turbine wheel because pressure recovery which is achieved by the connection adapter 110 allows for a greater pressure ratio across the turbine wheel and therefore an increase in the turbine wheel efficiency.

Defining part of the turbine outlet passage 116 by the connection adapter 110 is advantageous because different connection adapters can be fixed, or attached, to the same turbine housing 108 design. Different connection adapters may incorporate different features for different applications.

The connection adapter 110 further comprises a dosing module mount 122 and a NOx sensor mount 124. The dosing module mount 122 is engaged by the dosing module 126. The dosing module mount 122 thus aligns, and supports, the dosing module 126. The dosing module 126 is configured to inject aftertreatment fluid into the exhaust gas in the 4 turbine outlet passage 116. The dosing module mount 122 and the dosing module 124 are described in more detail below. The dosing module 126 is provided in fluid communication with a tank, or reservoir, in which a supply (e.g. volume) of aftertreatment fluid is stored.

The turbine dosing system 105 further comprises a NOx sensor 128 and a NOx sensor mount 124. The NOx sensor mount 124 is engaged by a NOx sensor 128. The NOx sensor 128 is configured to measure levels of NOx in the exhaust gas in the turbine outlet passage 116. Likewise, the NOx sensor mount 124 and the NOx sensor 128 is described in more detail below.

Finally, FIG. 2 also shows a wastegate passage outlet 138. The wastegate passage outlet 138 is an aperture defined in the interior surface 111 of the connection adapter 110. In use, exhaust gases can be diverted around the turbine wheel, through a wastegate passage 136 and into the turbine outlet passage 116 via the wastegate passage outlet 138.

Turning to FIG. 3, an alternative perspective view of the turbocharger 100 is provided.

FIG. 3 illustrates that the turbocharger 100 is a wastegate turbocharger comprising a wastegate arrangement 132. The wastegate arrangement 132 forms part of the turbine dosing system 105. The wastegate arrangement 132 comprises a valve assembly (not visible in FIG. 3) and the wastegate passage 136. As mentioned above, the wastegate passage 136 defines a fluid pathway from the turbine inlet passage 112 directly to the turbine outlet passage 116. The wastegate passage 136 is partly defined by the turbine housing 108 and partly defined by the connection adapter 110 in the illustrated embodiment. The wastegate passage 136 provides selective fluid communication between the turbine inlet passage 112 and the turbine outlet passage 116, bypassing the turbine wheel chamber and turbine wheel. As such, exhaust gas in the turbine inlet passage 112 can flow through the wastegate passage 136, to the turbine outlet passage 116, without passing through, or being expanded across, the turbine wheel 118.

The wastegate passage 136 comprises a wastegate passage inlet and the wastegate passage outlet (neither of which are visible in FIG. 3). The wastegate passage inlet is defined by an opening in a wall of the turbine housing 108 which defines the turbine inlet passage. The wastegate passage outlet 138 is defined by an opening in a wall of the connection adapter 110 (e.g. the interior surface 111 thereof). As such, exhaust gas flow passes into the wastegate passage 136 via the wastegate passage opening and leaves the wastegate passage 136 via the wastegate passage outlet 138. As the exhaust gas leaves the wastegate passage 136 it mixes with the exhaust gas in the turbine outlet passage 116.

The wastegate valve assembly comprises a valve member which is rotatable by an actuation rod 142. In use, the actuation rod 142 is configured to cause rotation of the valve member such that the valve member contacts, or does not contact, a corresponding valve seat, which is defined by the turbine housing 108. The valve member acts to selectively sealingly engage the valve seat to selectively open and close the wastegate passage 136 so as to permit, or substantially prevent, exhaust gas flow through the wastegate passage 136. When the valve member sealingly engages the valve seat, the wastegate passage 136 is effectively closed and all exhaust gas which passes through the turbine inlet passage is expanded across the turbine wheel. When the valve member does not sealingly engage the valve seat, the wastegate passage 136 is at least partly open and at least a portion of exhaust gas which passes through the turbine inlet passage is not expanded across the turbine wheel and is instead diverted around the turbine wheel via the wastegate passage 136. The valve seat may therefore be described as defining an inlet of the wastegate passage 136, and specifically a cross-sectional area of the inlet of the wastegate passage 136.

The actuation rod 142 is a pneumatic actuator in the illustrated embodiment. In other embodiments the actuator may be hydraulic or electric. The actuator may be active or passive.

The turbine 101 is a wastegate turbine (as indicated by the actuation rod 142). However, in some embodiments described throughout this document the turbine may not incorporate a wastegate assembly. The turbine may be a variable geometry turbine.

FIG. 4 is a side cross-sectional view of the turbocharger 100. FIG. 4 shows further features of the turbine dosing system 105 which forms part of the turbocharger 100.

The turbine wheel 118 is supported for rotation about the turbine wheel axis 144 by a shaft 146. The shaft 146 extends from the turbine housing 108 to the compressor housing 104 through the bearing housing 106. The turbine wheel 118 is mounted to one end of the shaft 146 and a compressor wheel 148 is mounted on the other end of the shaft 146. The turbine wheel 118 may be mounted to the end of the shaft 146 by friction welding, laser welding, electron beam welding, or any other suitable method. The turbine wheel 118 and the compressor wheel 150 are therefore in power communication with one another. The shaft 146 rotates about the turbine wheel axis 144 on bearing assemblies 150 located in the bearing housing 106.

The turbine outlet passage 116 is defined by the turbine housing 108 and the connection adapter 110 in the illustrated embodiment. The cross sectional area of the turbine outlet passage 116 increases linearly from the most upstream end of the passage (i.e. proximate the turbine wheel 118) to the most downstream end of the passage (i.e. distal the turbine wheel 118), so as to define a diffuser.

A flow axis 145 is defined by the turbine outlet passage 116. The flow axis 145 is the geometric centreline of the turbine outlet passage 116 as defined by the turbine housing 108 and the connection adapter 110. In this embodiment, and as will be appreciated from FIG. 7, the flow axis 145 is coincident with the turbine axis 144. However, in other embodiments, where the turbine outlet passage 116 is not a linear passage, i.e. the turbine outlet passage 116 may comprise a bend, the flow axis 145 will deviate away from the turbine wheel axis 144. See, for example, FIG. 18.

The turbine wheel 118 is visible in FIG. 4, and comprises a plurality of turbine blades 119. The turbine wheel 118 comprises an inducer 172 configured to receive exhaust gas flow 152a from the turbine inlet passage 112. The exhaust gas 152a is received in a radial direction relative to the turbine wheel axis 144. The turbine wheel 118 further comprises an exducer 174 configured to discharge the exhaust gas flow from the turbine wheel 118. The exhaust gas flow is discharged along a flow axis 145. The exducer 174 defines an exducer diameter 176. The exducer diameter 176 is the distance across the turbine wheel 118, in a plane normal to the turbine wheel axis 144, at downstream tips of the blades 119. A downstream end, or tip, of the turbine wheel 118 is labelled 178 in FIG. 4. In some embodiments the downstream end of the turbine wheel 118 may be defined by a wheel nut, the downstream end of the turbine wheel lying in a wheel nut plane. As will be described later in this document, the exducer diameter 176 is used as a metric for defining the position of the dosing module 126 with respect to the turbine wheel 118. An axial distance between the exducer 174 and the downstream end 178 of the turbine wheel 118 is around 10 mm in the illustrated embodiment, but it will be appreciated that this may vary in other embodiments. In the illustrated embodiment the exducer diameter 176 is approximately 60 mm (e.g. 58 mm). The exducer diameter is preferably between around 30 mm and around 200 mm. In contrast to cup-dosing arrangements, the downstream end 178 of the turbine wheel 178 is substantially flat (i.e. does not incorporate a dosing cup).

The cross sectional area of the upstream portion 116a of the turbine outlet passage 116 increases from the downstream end 178 of the turbine wheel 118. The cross sectional area increases linearly (i.e. the inner wall surface diverges at a constant angle). In other embodiments, the turbine outlet passage, or a portion thereof, may have a constant cross sectional area. In further embodiments, the turbine outlet passage may have a constant cross sectional area, and then the cross sectional area increases after a particular point along the flow axis. For example, the upstream portion of the turbine outlet passage, defined by the turbine housing, may be constant, and the downstream portion of the turbine outlet passage, defined by the connection adapter may have a cross sectional area that increases linearly.

In the illustrated embodiment, the interior surface 111 of the connection adapter 110 diverges linearly along the flow axis 145. In other embodiments, the interior surface 111 may diverge in a non-linear fashion. The angle of the divergence may be varied dependent upon the design conditions of each turbocharger. The divergence may be defined by an angle 121 by which inner wall surfaces 162a, 162b of a wall 162 of the connection adapter 110 are inclined relative to one another. The angle 121 may be described as a diffuser angle. The angle 121 is around 7.5° in the illustrated embodiment. The angle 121 may be between around 5° and around 20°. The angle 121 may be between around 6° and around 15°. The angle 121 may be between around 7° and around 10°. The wall 162 is an example of a structure which defines at least part of the turbine outlet passage 116. In other embodiments, the connection adapter 110 may define a constant cross-sectional area before diverging linearly along the flow axis 145.

The angle 121 thus defines a diffuser angle of the turbine outlet passage 116. In the illustrated embodiment, the diverging portion of the turbine outlet passage 116 extends continuously across both the upstream and downstream portions 116a, 116b of the turbine outlet passage 116 (e.g. as defined by the turbine housing 102 and the connection adapter 110). Described another way, the turbine outlet passage 116 diverges, at a constant angle, from an upstream point of the turbine outlet passage 116 (at the downstream end 178 of the turbine wheel 118) to at least a second end 335 of the connection adapter 110. Part of the divergence also extends further upstream of the downstream end 178 of the turbine wheel 118 into the wheel chamber 114. Part of the wheel chamber 114 thus diverges.

As previously described, the connection adapter 110 comprises the dosing module mount 122. The dosing module mount 122 is integrally formed with the connection adapter 110 in the illustrated embodiment. In other words, the dosing module mount 122 and the connection adapter 110 are a unitary structure. Accordingly, the dosing module mount 122 and the connection adapter 110 may be manufactured by casting the single, combined structure.

The dosing module 126 is a self-atomising dosing module that it is configured to inject aftertreatment fluid from an outlet 166 of the dosing module 126 as a fine spray. The dosing module 126 is configured to inject aftertreatment fluid into a bulk exhaust gas flow 152b in the turbine outlet passage 116 downstream of the turbine wheel 118. Because the aftertreatment fluid is injected as a fine spray, there is no need for the aftertreatment fluid to be injected into a structure which promotes atomisation of the aftertreatment fluid, such as a rotary dosing cup provided in the turbine wheel, before being mixed with the bulk exhaust gas flow 152b. The dosing module 126 injects aftertreatment fluid from the outlet 166 as a fine spray in a generally conical manner. A spray cone (of atomised aftertreatment fluid) is labelled 139.

A minimum distance 180 between a centroid of the outlet 166 of the dosing module 126 and the flow axis 145 defines an outlet intersection point 182 along the flow axis 145. A distance between the outlet intersection point 182 and the downstream end 178 of the turbine wheel 118, along the flow axis 145, defines a location of the dosing module 126 downstream of the turbine wheel 118. The distance between the downstream end 178 of the turbine wheel 118 and the intersection point 182 is approximately 2.4 exducer diameters (i.e. around 2.4 times the distance indicated by numeral 176) measured along the flow axis 145. In other embodiments, the intersection point 182 may be up to around 3 exducer diameters downstream of the downstream end 178 of the turbine wheel 118, measured along the flow axis 145. The intersection point 182 may be between around 3 and around 7 exducer diameters, downstream of the downstream end 178 of the turbine wheel 118, measured along the flow axis 145. In other embodiments, the distance between the downstream end 178 of the turbine wheel 118 and the outlet intersection point 182 may be different. However, said distance will be no more than around 10 exducer diameters. In the illustrated embodiment the distance between the downstream end 178 of the turbine wheel 118 and the intersection point 182 is approximately 100 mm. This distance preferably ranges from between around 50 mm to around 200 mm. The intersection point 182 may be at least 1 exducer diameter downstream of the downstream end 178 of the turbine wheel 118.

It will be appreciated that the position of the dosing module 126 and dosing module mount 122 are interdependent upon one another. For example, the dosing module 126 may be concentrically mounted with respect to the dosing module mount 122. The position of the dosing module 126, as defined by the outlet intersection point 182, may therefore be indicative of a position of the dosing module mount 122 (and may be the same). Any advantages described throughout this document, in relation to the position of the dosing module 126, are therefore equally applicable to the position of the dosing module mount 122.

By locating the dosing module 126, and so dosing module outlet 166, relatively close to the turbine wheel 118, decomposition of the injected aftertreatment fluid, into reductants, for example ammonia (NH₃) and Isocyanic Acid (HNCO), (to support a downstream SCR reaction) is improved. This is because the distance between where aftertreatment fluid is injected and a downstream selective catalytic reduction (SCR) catalyst is increased, and hence the time available for decomposition before reaching the SCR catalyst is also increased, thereby increasing the amount of decomposition of the injected aftertreatment fluid. This is particularly advantageous when operating at relatively low exhaust gas temperatures, for example at engine start-up.

Decomposition is improved, at least in part, because the swirl of the bulk exhaust gas flow 152b, after being discharged from the turbine wheel 118, is greater than, for example, the exhaust gas significantly downstream of the turbine wheel (e.g. in a decomposition chamber). Regions within the exhaust gas flow, having a high turbulent kinetic energy (beneficial for promoting the mixing of aftertreatment fluid with the bulk exhaust gas flow, due to increased momentum exchange between the aftertreatment fluid and the bulk exhaust gas flow) are thus present, and greater in magnitude, owing to the proximity to the turbine wheel 118. The higher turbulent kinetic energy of the bulk exhaust gas flow also promotes droplet break-up of the injected aftertreatment fluid. Increasing droplet break-up of aftertreatment fluid improves the uniformity of mixing of the aftertreatment fluid with the bulk exhaust gas flow and, in turn, increases decomposition of the aftertreatment fluid.

The temperature of the bulk exhaust gas flow 152b is also comparatively higher in proximity to the turbine wheel 118. The higher exhaust gas temperature promotes decomposition of the injected aftertreatment fluid by facilitating evaporation of the deionised water and the thermal decomposition of urea into constituent reductants. Decomposition is also promoted by way of higher convective heat transfer of the turbine bulk flow to the droplets of aftertreatment fluid.

The velocities of the bulk exhaust gas flow at the walls of the turbine outlet passage 116 are also higher closer to the turbine wheel 118 than at locations further downstream. The higher velocities generate comparatively high shear forces in these regions, and reduce the risk of aftertreatment fluid settling on the interior surface 111 (for example) which defines the turbine outlet passage 116. The risk of undesirable deposit build-up within the turbine outlet passage 116 is therefore also reduced. The comparatively high velocities of the turbine bulk flow also contribute to improved convective heat transfer to the aftertreatment fluid droplets.

The removal of harmful gases from the bulk exhaust gas flow 152b (e.g. the denoxification of exhaust gas) is thus promoted.

Because the dosing module mount 122 is provided in relative proximity to the turbine wheel 118, and so turbocharger 100 more generally, the dosing module 126 can be provided in close proximity to engine ancillaries (not shown). This, in turn, reduces the length of electrical and coolant cables, resulting in a more cost effective system. The same applies for the NOx mount and NOx sensor, and any other exhaust gas sensor and respective mounting arrangement(s) which may be provided.

The placement of the dosing module 126, in accordance with the invention, is thus advantageous in overcoming problems associated with: i) poor decomposition of the aftertreatment fluid due to low exhaust gas temperatures and/or low turbulent kinetic energy of the exhaust gas flow; ii) packaging considerations/constraints when locating the dosing module significantly downstream of the engine; iii) unwanted system backpressure due to the use of a traditional, downstream decomposition chamber, which can decrease the efficiency of an upstream engine; iv) aftertreatment deposit formation on any proximate interior surfaces; and v) high thermal mass of the downstream aftertreatment components (e.g. decomposition chamber) of a traditional system.

Also of note, in the illustrated embodiment the bypass flow 152c is discharged through the wastegate passage outlet 138 directly into a same region of the turbine outlet passage 116 that the aftertreatment fluid is injected into. The region may be referred to as a mixing zone, which is provided directly downstream of the turbine wheel 118. The mixing zone may extend across an entirety of the turbine outlet passage 116 normal to the flow axis 145. This is in contrast to, for example, an embodiment where a diffuser insert (e.g. an internal diffuser pipe, or secondary wall) may (axially) separate the primary impingement zone of the aftertreatment fluid from the bypass flow 152c (at least initially). For example, in such embodiments the bypass flow may initially flow around the diffuser insert and, only downstream of the diffuser insert, mix with aftertreatment fluid injected into an interior of the diffuser insert. In the illustrated embodiment the bypass flow 152c and aftertreatment fluid are directly introduced into the mixing zone directly downstream of the turbine wheel 118. This may also be described as a single skin (e.g. single wall) arrangement (i.e. no secondary wall, or diffuser insert, is present).

The wastegate passage outlet 138 at least partially overlaps the outlet 166 of the dosing module 126 along the flow axis 145 in the illustrated embodiment (although this may not the case in other embodiments). Described another way, the wastegate passage outlet 138 is positioned, along the flow axis 145, so that the outlet intersection point 182 (indicating the position of the outlet 166 of the dosing module 126) lies within an axial extent of the wastegate passage outlet 138. The wastegate passage outlet 138 is circumferentially spaced from the outlet 166 about the flow axis 145. As also shown in FIG. 7, the wastegate passage outlet 138 is circumferentially spaced, by approximately 90 degrees around the flow axis 145, from the outlet 166 of the dosing module 126.

Returning to FIG. 4, the wastegate passage 136 is aligned such that a wastegate passage exhaust gas flow 152c (i.e. a bypass flow) exits the wastegate passage outlet 138, and enters the turbine outlet passage 116 (specifically the downstream portion 116b thereof), with a velocity which is generally tangential to the flow axis 145. This is also indicated in FIG. 7.

Introducing the wastage passage exhaust gas flow 152c, into the bulk exhaust gas flow 152b, with a generally tangential velocity promotes mixing of the injected aftertreatment fluid with the bulk exhaust gas flow 152b. This improved mixing means that the aftertreatment fluid is uniformly distributed in the bulk exhaust gas flow 152b and therefore increases the amount of harmful gases which can be removed from the bulk exhaust gas flow 152c. In addition, the wastegate passage exhaust gas flow 152c has a relatively higher energy density than the bulk exhaust gas flow 152b, which has passed through the turbine wheel 118. Introducing exhaust gas with higher energy density (including a higher temperature) facilitates decomposition of the injected aftertreatment fluid more swiftly, and more fully, compared to if it was injected into only the bulk exhaust gas flow 152c (i.e. in the absence of a wastegate passage).

The elongate geometry of the wastegate passage outlet 138 (e.g. the aperture being letterbox-shaped) in the flow axis 145 direction, and the tangential introduction of the wastegate passage exhaust gas flow 152c, advantageously generates comparatively high shearing forces in the wastage passage exhaust gas flow 152c. The shearing forces are generated by virtue of a layer of comparatively high velocity exhaust gases proximate the interior surface 111. Such shearing forces are desirable for reasons of improved mixing of aftertreatment fluid with exhaust gas, and reduced risk of deposit build-up on the interior surface 111, particularly proximate a primary impingement zone (e.g. a surface generally opposite the outlet 166 of the dosing module 126, and bound by spray cone 139). The letterbox-shaped wastegate passage outlet 138 also means that the shearing forces are generated over a comparatively larger surface area (e.g. along the flow axis 145).

The wastegate passage outlet 138 has an axial extent 155 (e.g. width) of around 50 mm (e.g. 52 mm) in the illustrated embodiment. The wastegate passage outlet 138 is preferably between around 30 mm and around 100 mm in axial extent. The wastegate passage outlet 138 has a height 157. In the illustrated embodiment the height 157 is around 5 mm (e.g. 6 mm). The height 157 is preferably between around 3 mm and around 20 mm. A ratio of the axial extent 155 to the height 157 of the wastegate passage outlet 138 defines an aspect ratio of the outlet. In the illustrated embodiment the ratio is around 9:1 (e.g. 8.7:1). The ratio is preferably between around 6:1 and around 10:1.

In the illustrated embodiment a centroid of the wastegate passage outlet 138 is located around 100 mm downstream of the downstream end 178 of the turbine wheel 118. In other embodiments centroid may be located closer to, or further away from, the downstream end 178 (e.g. between around 50 mm and around 200 mm separation between the centroid and the downstream end 178).

In the side cross sectional view of the turbocharger in FIG. 4, the NOx sensor mount and the NOx sensor are not visible. However, these features will be described in connection with FIGS. 6 to 8.

Turning to FIG. 5, an enlarged view of the dosing module mount 122 and the dosing module 126 shown in FIG. 4 is provided.

The dosing module mount 122 comprises a boss 158. The dosing module mount 122 projects from the connection adapter 110, relative to the flow axis (in a generally radially outwards direction). The boss 158 comprises a first recess 160. The first recess 160 extends from a radially distal end 159 of the boss 158 to partway through the wall 162 of the connection adapter 110 (which defines the turbine outlet passage 116). The wall 162 of the connection adapter comprises an opening 164, which is an aperture through the wall 162. The opening 164 is concentric with the first recess 160 of the boss 158. The first recess 160 is provided in fluid communication with the opening 164 (at least in the absence of the dosing module 126). The opening 164 may be referred to as a dosing aperture. The opening 164 places the dosing module mount 122 in communication with the turbine outlet passage (e.g. as defined by the interior surface 111 of the connection adapter). To accommodate a dosing nozzle 170 having a diameter of around 12 mm, the opening 164 is between around 13 mm and around 14 mm in the illustrated embodiment. It will be appreciated that the nozzle 170 and opening 164 may be of a variety of different dimensions. For example, the nozzle 170 may be between around 5 mm and around 20 mm.

The first recess 160 is sized to receive at least a dosing end 168 of the dosing module 126. The dosing end 168 comprises the nozzle 170. The nozzle 170 defines the outlet 166 through which aftertreatment fluid is ejected as a fine spray. The dosing module 126 is therefore configured to inject aftertreatment fluid from the outlet 166 of the dosing module 126 through the opening 164 and into the bulk exhaust gas flow in the turbine outlet passage 116.

The opening 164 in the wall 162 of the connection adapter 110 has a smaller diameter than the first recess 160 of the boss 158. In particular, the opening 164 has a diameter that is substantially equal to a diameter of the nozzle 170 of the dosing module 126. This is beneficial as it mitigates against aftertreatment fluid, which is ejected from the outlet 166, from travelling back into the first recess 160.

The outlet 166 of the dosing module 126 is substantially aligned with an interior surface 111 defined by the wall 162 of the connection adapter 100. The outlet 166 is thus substantially flush with the interior surface 111 of the connection adapter 110. As such, the nozzle 170 of the dosing module does not project into the turbine outlet passage 116. Put another way, the turbine outlet passage 116 is not obstructed or blocked. If the nozzle 170 were to extend into the turbine outlet passage 116, it could be an obstruction to the bulk exhaust gas flow, reducing the efficiency of the turbine wheel 118 and potentially the efficiency of the internal combustion engine. Despite the above, in other embodiments the nozzle 170 may protrude into the turbine outlet passage 116 (e.g. proud of the opening 164).

The dosing module 126 further defines the dosing module axis 167. The dosing module axis 167 extends through the centroid of the dosing module outlet 166. In the illustrated embodiment the centroid of the opening 164 in the connection adapter 110 intersects the dosing module axis 167. For the avoidance of doubt, the centroid of the dosing module outlet 166 refers to the geometric centre of the outlet 166, and the centroid of the opening 164 refers to the geometric centre of the opening 164.

FIG. 5 shows how the outlet 166 of the dosing module 126 is substantially flush with the interior surface 111 of the connection adapter 110. Substantially flush is intended to mean that the outlet 166 is within around ±2 mm, along the dosing module axis 167, of the opening 164 in the interior surface 111. This advantageously reduces the risk that exhaust gas recirculates proximate the outlet 166 of the dosing module 126.

Although not shown in FIG. 5, the dosing module 126 may be secured to the dosing module mount 122 by way of a clamp, such a V-band clamp, and/or using one or more fasteners, such as bolts and/or screws. The dosing module 126 is preferably an externally attachable module. The dosing module 126 is preferably installed, and detachable, from an exterior of the dosing system.

In a method of installing the dosing module 126, or assembling the turbine dosing system more generally, a first method step comprises urging the dosing module 126 into engagement with the dosing module mount 122. A subsequent step may comprise securing the dosing module 126 to the dosing module mount 122. The securing may be by way of a clamp, which may be secured around flanges of the dosing module 126 and dosing module mount 122.

The dosing module mount 122 is integral with the surrounding connection adapter structure. Advantageously, the need to weld a separate dosing module mount onto the connection adapter is thus eliminated. Eliminating the need to weld a separate dosing module mount to the connection adapter is desirable because welding can lead to material changes and/or create regions more prone to corrosion. The assembly time, and so associated production costs, are therefore reduced in comparison to embodiments where the dosing module mount is first connected (e.g. welded) to the surrounding structure. Providing an integrated, or integral, doing module mount 122 also reduces the number of joints present, thereby reducing the likelihood of failure of the connection adapter as a whole.

A dosing module mount similar to the dosing module mount 158 is shown in isolation in FIGS. 11 and 12, and is described in more detail below.

For completeness, any dosing module mount described throughout this document may be incorporated as part of a turbine housing (e.g. a monoblock turbine housing), a connection adapter or a conduit.

FIG. 6 is an alternative cross sectional view of the turbine housing assembly 102 of turbocharger 100.

The connection adapter 110 further defines an exhaust gas sensor channel 300. For this embodiment, the exhaust gas sensor channel 300 is for use with a NOx sensor 128. The exhaust gas sensor channel 300 may therefore be interchangeably referred to as a NOx sensor channel 300, although it will be appreciated that other exhaust gas sensors may be used in combination with the channel 300 in other embodiments.

The NOx sensor channel 300 is configured to receive exhaust gas from the bulk exhaust gas flow 152b upstream of the dosing module outlet 166. The exhaust gas in the NOx sensor channel 300, herein referred to as the NOx sensor exhaust gas flow 152d, therefore does not contain any aftertreatment fluid.

The exhaust gas sensor channel 300 is around 100 mm in axial extent in the illustrated embodiment. The exhaust gas sensor channel 300 is preferably between around 20 mm and around 250 mm in axial extent. An end of the exhaust gas sensor channel 300 located proximate the turbine wheel 118 (e.g. an upstream end of the exhaust gas sensor channel) is axially offset from the downstream end 178 of the turbine wheel 118 by around 40 mm in the illustrated embodiment. The upstream end of the exhaust gas sensor channel 300 is preferably offset from the downstream end 178 of the turbine wheel 118 by between around 10 mm and around 100 mm.

The exhaust gas channel 300 (which may otherwise be referred to as a chamber) provides for an aliquot (e.g. a portion) 152d of exhaust gases to be separated from the turbine bulk flow 152b of exhaust gases. The exhaust gas channel 300 is configured to reduce one or both of the velocity and the pressure of the exhaust gases 152d therein, which allows an exhaust gas sensor (e.g. NOx sensor 128 in FIG. 6) to be positioned within the exhaust gas channel 300 and provides a less hostile environment for the sensor. This also allows the exhaust gas sensor 128 to be positioned further upstream than would otherwise be the case. This allows for the placement of an exhaust gas sensor 128 downstream of the turbine wheel 118 without there being an intervening catalyst unit or filter unit between the turbine wheel 118 and the exhaust gas sensor 128. In addition, exhaust gas sensors, particularly NOx sensors, may have their readings adversely affected by the presence of reductants added to the exhaust gases to reduce NOx levels. As such, by providing exhaust gas channel 300, which is separate to the turbine bulk flow of exhaust gases 152b, an exhaust gas sensor 128 disposed within the exhaust gas channel 300 is protected from the reductants added to the exhaust gases. In this way, the exhaust gas sensor 128 is able to measure the composition of the exhaust gases without the reading being affected by the presence of reductants which have been injected into the exhaust gases. Without the protection afforded by the exhaust gas channel 300, exhaust gas sensors, particularly NOx sensors, can be damaged by exposure to DEF and can provide incorrect readings. Despite the above, it will be appreciated that, in some embodiments, the exhaust gas channel 300, and sensor 128, may be omitted.

The exhaust gas channel 300 includes a channel wall 304. The channel wall 304 at least partially defines the exhaust gas channel 300. The channel wall 304 also at least partly defines the turbine outlet passage 116 at an opposing side to the exhaust gas channel 300. The channel wall 304 is configured to separate an aliquot of exhaust gases 152d from the turbine bulk flow 152b of exhaust gases. The channel wall 304 is radially inset (e.g. recessed) from the surrounding interior surface 111 (which defines the turbine outlet passage 116) to allow the aliquot of exhaust gas 152d which is to be measured to be split off from the turbine bulk flow 152b of exhaust gases. The exhaust gas channel 300 is configured to allow the aliquot of exhaust gases 152d to expand therein. The exhaust gas channel 300 has an inlet 306 and an outlet 308.

The NOx sensor 128 is mounted to the NOx sensor mount 124 in a position which allows a portion (e.g. a tip) of the NOx sensor 128 which is operable to measure a property of exhaust gas to be exposed to any exhaust gases 152d within the exhaust gas channel 300. In the illustrated embodiment the NOx sensor 128 is secured using fasteners 125, 127, but in other embodiments the NOx sensor may be secured using alternative means (e.g. a V-band clamp). As mentioned above, the NOx sensor is just one example of exhaust gas sensor, and other sensors may otherwise be employed (those sensors optionally utilising an exhaust gas sensor channel).

As described above in relation to FIG. 4, and as shown in FIG. 6, the wastegate passage outlet 138 axially overlaps the outlet 166 of the dosing module 126 (along the flow axis 145). The wastegate passage outlet 138 and the outlet 166 of the dosing module 126 are also circumferentially spaced by approximately 90 degrees (about the flow axis 145). The NOx sensor 128 does not axially overlap with the dosing module outlet 166. Instead, the NOx sensor 128 is located axially upstream of the dosing module outlet 166. The NOx sensor 128 is circumferentially spaced from the centroid of the outlet 166 of the dosing module 126 by approximately 90 degrees in the opposite direction to the circumferential spacing of the centroid of the wastegate passage outlet 138. Accordingly, the NOx sensor 128 is circumferentially spaced from the centroid of the wastegate passage outlet 138 by approximately 180 degrees. The position of the NOx sensor 128 may be defined by a NOx sensor axis 302.

The NOx sensor 128 is very sensitive to high gas velocities, temperature fluctuations, pressure fluctuations and corrosive chemicals and fluids. The NOx sensor 128 is particularly sensitive to high gas velocities because, in the illustrated embodiment, the NOx sensor 128 incorporates an internal heater which seeks to maintain a sensor at around 1073° Kelvin. High velocity exhaust gas may actually cool the sensor, by virtue of convective cooling, and the NOx sensor 128 may be forced to run high duty cycles in response in an attempt to maintain the sensor temperature at around 1073° Kelvin.

By locating the NOx sensor 128 in the NOx sensor channel 300, the NOx sensor 128 is not directly exposed to the highest velocity exhaust gas flow in the turbine outlet passage 116. In a similar manner, the NOx sensor 128 only samples exhaust gas from the bulk exhaust gas flow 152b. Any NOx readings are thus representative of a bulk exhaust gas flow 152b.

Further, it will be appreciated that the reductants produced by thermal breakdown of the urea in the aftertreatment fluid may be corrosive to particular metals, such as iron and aluminium. By providing the dosing module outlet 166 downstream of the NOx sensor 128, and by shielding the NOx sensor 128 within the NOx sensor channel 300, aftertreatment fluid is substantially prevented from contacting the NOx sensor 128 or forming deposits at, or proximate, the NOx sensor 128.

To further protect the NOx sensor 128, the dosing module 126 is configured to inject aftertreatment fluid in a generally downstream direction (e.g. with the bulk exhaust gas flow 152b). In the illustrated embodiment the dosing module 126 is angled at around 7° off vertical (e.g. 7° off of normal to the flow axis 145) in the downstream direction, which is perpendicular to the tapered interior surface 111 (e.g. the diffuser cone) at the outlet 166 of the dosing module 126. By injecting the aftertreatment fluid into the bulk exhaust gas flow 152b in a generally downstream direction (i.e. away from the turbine wheel 118), the risk of aftertreatment fluid, and associated byproducts, contacting the NOx sensor 128 is reduced. It will, nevertheless, be appreciated that, in other embodiments, the dosing module 126 may be angled to inject aftertreatment fluid into the bulk exhaust gas flow in a generally perpendicular direction relative to the flow axis 145. In other embodiments, the dosing module 126 may be configured to inject aftertreatment fluid in a generally upstream direction (i.e. towards the turbine wheel 118).

Although not shown in illustrated embodiment, the turbine outlet passage 116, the NOx sensor channel 300, the dosing module mount 122 and/or the NOx sensor mount 124 may be at least partly formed from, or lined with, stainless steel. This is desirable for the reason that stainless steel is resistant to corrosion from byproducts formed by the injected aftertreatment fluid. It is therefore desirable that at least a primary impingement zone (e.g. a surface generally opposite the outlet of the dosing module) be formed from stainless steel, or be lined with stainless steel. Other materials which are also resistant to corrosion may be utilised in place of, or in combination with, stainless steel. Coatings and/or surface treatments may also be utilised to improve corrosion resistance.

For similar reasons to those described above, it is also advantageous to provide a stainless steel surface at any bends and/or diverging portions (e.g. diffusers) in the turbine outlet passage (by way of a lining, or by using stainless steel to manufacture the surrounding structure). Furthermore, stainless steel linings may advantageously be provided at any joints, or interfaces, between components which define the turbine outlet passage. For example, a stainless steel sleeve may be provided between the turbine housing and the connection adapter to reduce the risk of corrosion at the joint line therebetween.

FIG. 7 is an end view of the turbocharger 100 from the turbine housing assembly 102 end. The relative circumferential spacing of the dosing module 126, the NOx sensor 128 and the wastegate passage outlet 138, about the flow axis 145, is visible in FIG. 7. Further features of the turbine dosing system 105 are thus visible. FIG. 7 also shows the outlet 308 of the exhaust gas sensor channel 300.

An angle 311 between the dosing module axis 167 and the central axis 302 of the NOx sensor 128 (i.e. a circumferential offset between the dosing module 126 and the NOx sensor 128) is approximately 90 degrees (about the flow axis 145). The angle 311 may is preferably between around 30 degrees and around 90 degrees. Similarly, an angle 313 between a wastegate passage outlet axis 310, which passes the through the centroid of the wastegate passage outlet 138, and the dosing module axis 167 (i.e. a circumferential offset between the centroid of the wastegate passage outlet 138 and the dosing module 126), is also approximately 90 degrees about the flow axis 145. The angle 313 is preferably between around 30 degrees and around 110 degrees. An angle 315 between the wastegate passage outlet axis 310 and the central axis 302 of the NOx sensor 128 (i.e. a circumferential offset between the centroid of the wastegate passage outlet 138 and the NOx sensor 128) is approximately 180 degrees. The angle 315 is preferably between around 75 degrees and around 180 degrees. In the illustrated embodiment the dosing module 126 interposes the wastegate passage outlet 138 and the NOx sensor 128 circumferentially.

The dosing module 126 is configured to inject aftertreatment fluid into the turbine outlet passage 116, such that the spray cone 139 of aftertreatment fluid does not impinge on the wastegate passage outlet 138. Described another way, it is desirable that the spray cone 139 does not overlap the wastegate passage outlet 138 circumferentially.

The NOx sensor 128 is circumferentially positioned to facilitate access to the fasteners which couple the connection adapter 110 to the turbine housing 108. The combination of the NOx sensor 128 and dosing module 126 are positioned to preferably avoid aftertreatment fluid impinging upon the NOx sensor 128. Described another way, it is desirable that the spray cone 139 does not overlap with the NOx sensor 128 circumferentially.

To avoid aftertreatment fluid pooling at the outlet 166 of the dosing module 126, when the turbocharger 100 is installed in an engine system, the outlet 166 of the dosing module 126 is preferably positioned circumferentially outside of a lowermost 90° sector about the flow axis 145. Described another way, the dosing module axis 167 preferably lies outside of a vertically lowermost ¼ of the circumference of the turbine outlet passage 116 at that axial position along the flow axis 145. The risk of the outlet 166 of the dosing module 126 becoming blocked by stagnant aftertreatment fluid following, for example, key-off, is therefore reduced by effectively mounting the dosing module 126 so as to provide an angle of runoff, at the outlet 166, of any stagnant aftertreatment fluid.

The NOx sensor 128 is preferably positioned within an uppermost 160° sector about the flow axis 145. Described another way, the NOx sensor 128 is preferably installed at least above 10° of horizontal about the flow axis 145. This is to facilitate the draining of fluid (e.g. water vapour from exhaust gas, which may condense on interior surfaces following key-off) from the NOx sensor 128. The risk of failure of ceramic elements (e.g. forming part of the sensor) which may be present in the NOx sensor 128, over numerous thermal cycles, is also reduced.

FIG. 7 also shows that the connection adapter 110 is secured to (i.e. connected to) the turbine housing 108 by a plurality of fasteners 312 (only one of which is labelled in FIG. 7). The fasteners 312 are bolts in the illustrated embodiment, although it will be appreciated that other fasteners could otherwise be used. Similarly, a clamp (e.g. a V-band clamp) could otherwise be used to secure the connection adapter to the turbine housing in other embodiments. The fasteners 312 extend through a respective bore in for the connection adapter 110 (e.g. see FIG. 9), and threadably engage a corresponding threaded bore in the turbine housing 108. The plurality of fasteners 312 may be said to define an asymmetric bolt pattern. Advantageously, this ensures the correct orientation of the connection adapter 110 on the turbine housing 108 (e.g. a poka-yoke functionality/feature). One or more of the plurality of fasteners 312 may be oriented at a relative angle to the axis 145 (e.g. in a non-axial direction). Orienting one or more of the plurality of fasteners 312 at a relative angle improves tool access (e.g. reduces the risk of a head of one or more of the fasteners 312 being obstructed, or obscured, by another component (such as the connection adapter 110 itself).

FIG. 7 also shows the wastegate passage exhaust gas flow 152c entering the turbine outlet passage 116 in a generally tangential direction. As indicated in FIG. 7, wastegate passage exhaust gas flow 152c swirls in a generally counterclockwise direction when viewed from an outer end of the connection adapter 110. This direction of swirl is the same direction as the swirl of the bulk exhaust flow 152b once expanded across the turbine wheel 118. As such, the wastegate passage exhaust gas flow 152c may be said to swirl in the same direction as the bulk exhaust flow 152b. The swirl direction may be described in relation to a direction in which the volute 113 extends, around the turbine wheel axis (which, in the illustrated embodiment, is coincident with the flow axis 145) towards the wheel chamber. Specifically, the exhaust gas flow swirls in the same direction as the volute 113 extends. The swirl direction of the bulk exhaust flow 152b may vary with engine operation condition. For example, in some operating conditions the bulk exhaust flow, or a portion of the bulk exhaust flow, may swirl in the opposite direction to that which the volute 113 extends. For example, at operating conditions whereby the turbine achieves a peak power output, the bulk exhaust flow may swirl in substantially the same direction as the volute 113 extends. Whereas, if the turbine is operating at a lower load condition, then a portion, or all, of the bulk exhaust flow may swirl in a direction which is opposite the direction in which the volute 113 extends.

FIG. 8 is a cross sectional end view of the turbocharger 100 taken from the plane A-A indicated in FIG. 4.

FIG. 8 illustrates that the NOx sensor 128 is axially upstream (i.e. closer to the turbine wheel 118) of the dosing module 126. This is for reasons of reducing the risk of aftertreatment fluid impinging upon the NOx sensor 128.

FIG. 8 illustrates how the dosing module mount 122 and the NOx sensor mount 124 are both integral with the connection adapter 110. In other words, the dosing module mount 122 and the NOx sensor mount 124 form a unitary structure with the connection adapter 110. In other embodiments, the dosing module mount 122 and/or the NOx sensor mount 124 may be formed from separate components which are subsequently connected to the connection adapter 110.

FIG. 8 also shows part of the wastegate passage 136, the valve member 140, and more of the path taken by the wastegate passage exhaust gas flow 152c.

Turning to FIG. 9, a perspective cross-sectional view of an effective cavity, which defines a volume of part of the turbine dosing system 102 through which exhaust gas can flow, is provided. FIG. 9 shows a region of particular interest of the wastegate passage 136 (e.g. as shown in FIG. 8).

The wastegate passage 136, via the wastegate passage outlet 138, is configured to deliver wastegate passage exhaust gas 152c flow, from the wastegate passage 136 into the turbine outlet passage 116, in a substantially tangential direction (relative to the flow axis 145. That is to say, the wastegate passage 136 is configured to deliver (bypass) exhaust gas into the turbine outlet passage 116 in a direction such that it swirls about the flow axis 145. As such, any disturbance of the turbine bulk flow in the turbine outlet passage 116 by the exhaust gas which exits the wastegate passage 136 is reduced (assuming the exhaust gas in the wastegate passage 136 is delivered in a swirl direction with, rather than in an opposing swirl direction of, the turbine bulk flow). The wastegate passage exhaust gas 152c flow may be introduced at an angle of up to around +5° to a ‘true’ tangential direction with respect to the turbine outlet passage 116. In other embodiments, the wastegate passage 136 may be configured to deliver exhaust gas into the turbine outlet passage 116 in a generally axial direction relative to the flow axis 145.

The wastegate passage 136 does not have a constant cross-sectional area along its extent (e.g. from the wastegate passage inlet to the wastegate passage outlet 138). In particular, the cross-sectional area of the wastegate passage 136 varies (e.g. increases) from the wastegate passage inlet (not visible in FIG. 9), towards the wastegate passage outlet 138. At an upstream-most point 143 of the wastegate passage outlet 138, the cross-sectional area of the wastegate passage 136, indicated by dashed lines, defines a critical area 141 of the wastegate passage 136. The critical area 141 defines an effective flow area of the wastegate passage 136 and, in particular, an effective flow area through which exhaust gas flowing through the wastegate passage 136 may flow. The critical area 141 may be described as being normal to the direction of the (bypass) exhaust gas in the wastegate passage 136. The critical area 141 may be described as a narrowest point (e.g. smallest cross-sectional area, which may be referred to as a bypass area) of the wastegate passage 136 downstream of the wastegate passage inlet (e.g. upstream of the turbine outlet passage 116). Although FIG. 9 is a cross-sectional view, cutting through part of the critical area 141 (e.g. artificially reducing the critical area size), it will be appreciated that the actual critical area 141 extends across an entire axial extent of the wastegate passage outlet 138.

The critical area 141 is around 120% (around 1.2 times) larger than the cross-sectional area of the wastegate passage inlet. The area of the wastegate passage inlet may be defined by a valve seat (e.g. when the corresponding valve member is in an open configuration). The valve seat may otherwise be described as a wastegate port. The cross-sectional area of the wastegate passage inlet may define a smallest cross-sectional area along the wastegate passage. In other embodiments the critical area 141 may be between around 100% and around 180% (between around 1 and 1.8 times) of the cross-sectional area of the wastegate passage inlet, and preferably between around 100% and around 150% (between around 1 and 1.5 times) of the cross-sectional area of the wastegate passage inlet. The increase in cross-sectional area of the wastegate passage 136 from the wastegate passage inlet to the critical area 141 compensates for frictional and pressure losses in the exhaust gas as it passes through the wastegate passage 136 (e.g. compensates for friction and pressure losses downstream of the valve member). Furthermore, any frictional/pressure drop losses are compensated for by the increase in cross-sectional area. The bypass exhaust gas flow is therefore no more choked, along the wastegate passage 136, than at the wastegate passage inlet (e.g. at the valve seat). Constriction of bypass exhaust gas flow downstream of the wastegate passage inlet may therefore be avoided. This is desirable for the reason that flow through the wastegate passage 136 can be directly controlled by actuation of the valve member, across a whole range of operation, without being affected by constriction of exhaust gas flow downstream of the valve member. The proportion of bypass exhaust gas flow which enters the turbine outlet passage 116 can therefore be controlled by actuation of the valve member.

Nevertheless, as mentioned above, in other embodiments the cross sectional area of the critical area 141 may be substantially the same as the cross-sectional area of the wastegate passage inlet.

FIG. 10 is a perspective view of the connection adapter 110 in isolation. As will be appreciated from earlier Figures, the connection adapter 110 forms part of a turbine dosing system.

The connection adapter 110 defines the interior surface 111 which, in turn, defines the downstream portion 116b of the turbine outlet passage 116 (as shown in FIG. 4). As mentioned above, the downstream portion 116b of the turbine outlet passage 116 may otherwise be described as a connection adapter passage.

The connection adapter 110 comprises a webbed portion 318 at the first end 115 of the connection adapter 110 (e.g. the end proximate the turbine housing when assembled as part of a turbine housing assembly). The webbed portion 318 is configured to engage the turbine housing 108 (optionally via an interposing gasket). The webbed portion 318 may be referred to as a first connection portion.

The webbed portion 318 further defines a number of flanged arm portions 320 (only one of which is labelled in FIG. 9) which extend outwardly away from a flow axis. The flanged arm portions 320 each comprise a bore 322 for receiving a fastener, such as a bolt, therethrough. When the first end 115 of the connection adapter 110 engages the turbine housing 108, the bores 332 align with corresponding bores provided in the turbine housing 108. Fasteners can therefore extend through the bores 322 and into the corresponding (threaded) bores of the turbine housing 108. In order to form a secure seal between the connection adapter 110 and the turbine housing 108, a gasket (see gasket 117 in FIG. 4) may be provided between the connection adapter 110 and the turbine housing 108. The gasket may be formed from graphite, steel, copper or a composite of multiple materials. Exhaust gas leakage from between the connection adapter 110 and the turbine housing 108 is thus substantially prevented.

The connection adapter 110 further comprises a flange 325. The flange 325 may otherwise be described as a second connection portion. The flange 325 is disposed at a second end 335 of the connection adapter 110. The flange 325 is configured to engage a downstream conduit (specifically a corresponding connection portion thereof). The wall 162 of the connection adapter 110 forms part of a structure which extends from the first end 115 of the connection adapter 110 to the second end 335 of the connection adapter 110.

The dosing module mount 122, as previously described, comprises the boss 158. The boss 158 extends in a generally radial direction from the wall 162 of the connection adapter 110 (relative to the flow axis 145).

The first recess 160 of the boss 158 is configured to receive at least part of the dosing module (e.g. at least the dosing end of the dosing module). The first recess 160 does not have a constant diameter. An internal stepped portion 328 is defined at an end 331 of the first recess 160 which is proximate the flow axis 145. A second recess 161, which may be described as defining at least part of an opening, is defined between the interior surface 111 and the first recess 160. The second recess 161 has a constant diameter in the illustrated embodiment. The second recess 161 may be described as a through-bore. The second recess 161 places the first recess 160 in fluid communication with the portion of the turbine outlet passage defined by the connection adapter 110. The second recess 161 receives the nozzle 170 (see FIG. 5) of the dosing module. The combination of the first and second recesses 160, 161 may be described as resembling a stepped bore, or a blind bore.

The internal stepped portion 328 may receive a gasket, for example a graphite gasket, to be provided between the stepped portion 328 and the dosing module (to aid sealing therebetween). A seal may therefore be formed between the dosing module and the dosing module mount 122. A graphite gasket, in particular, is advantageous for reasons of corrosion resistance and high temperature durability.

The boss 158 comprises first and second portions 324, 326. The first portion 324 is proximate the flow axis 145 (and directly extends from the wall 162 of the connection adapter 110). The second portion 326 extends from the first portion 324. The second portion 324 is inwardly offset relative to the first portion 324 such that an external stepped portion 327 is defined between the portions 324, 326. The first portion 324 is also at least partially hollow, defining at least part of the first recess 160 for receiving the dosing module. The first and second portions 324, 326 may be referred to as inner and outer portions, respectively, with respect to the flow axis 145.

The boss 158 further comprises a flange 329. The flange 329 is disposed at an outer end of the second portion 326 of the boss 158 (with respect to the flow axis 145). An end face 330 of the flange 329 defines an engagement surface. The dosing module engages at least the engagement surface (directly or indirectly), defined by the end face 330, when installed in situ. Put another way, engagement between the dosing module and at least the engagement surface of the dosing module mount 122 provides at least some, if not all, of the alignment, and support, of the dosing module.

In use, the dosing module may be secured to the dosing module mount 122 through means of a clamp, for example a V-band clamp. Alternative attachment means include the use of fasteners, or a threaded engagement of the dosing module with the dosing module mount.

FIG. 11 is a perspective view of part of a connection adapter 410 according to another embodiment of the invention. For completeness, FIG. 12 is a cross sectional view of the connection adapter 410 of FIG. 11. The connection adapter 410 forms part of a turbine dosing system. The connection adapter 410 is thus for an aftertreatment fluid dosing turbine housing assembly.

The connection adapter 410 comprises a first end (not shown) for engaging a turbine housing and a second, opposing, end 412, which is configured to engage a downstream conduit. Specifically a flange 413 (which may be referred to as a second connection portion) is provided at the second end 412 and is configured to engage the downstream conduit. The connection adapter 410 defines a connection adapter passage 414. The connection adapter passage 414 may be said to be defined by an interior surface of the connection adapter 410. When the connection adapter 410 engages a turbine housing (such as the turbine housing 108 shown in FIGS. 2 to 11), the connection adapter channel 414 defines at least a portion of a turbine outlet passage.

The connection adapter 410 comprises a dosing module mount 416. The dosing module mount 416 is configured to align, and support, a dosing module. Like the dosing module mount 122 described in connection with FIG. 10, with which the dosing module mount 416 shares many features in common, the dosing module mount 416 comprises a boss 418. The dosing module mount 416 is integral with a surrounding structure (defining the connection adapter passage 414) of the connection adapter 410. Providing the dosing module mount 416 and the connection adapter as an integral structure is advantageous, as manufacturing time and hence production cost is decreased, due to obviating the need to weld a dosing module mount onto the connection adapter. Providing an integrated doing module mount 416 reduces the number of joints present, thereby reducing the likelihood of failure of the component.

Turning to FIG. 12, the boss 418 comprises a bore 420, which may be referred to as a second recess, which is configured to receive a portion of a dosing module (not shown). The connection adapter 410 comprises a wall 424 which defines at least part of the connection adapter passage 414. The wall 424 is an example of a structure, the wall extending from a first end of the connection adapter 410 to the second end 412. An opening 422 is defined in the wall 424 of the connection adapter 410. Accordingly, there is a fluid pathway through the bore 420 and through the opening 422 into the connection adapter passage 414. A dosing module can thus inject aftertreatment fluid into (exhaust gas in) the connection adapter passage 414 through the opening 422 of the connection adapter 410.

The dosing module mount 416 defines a dosing module mount axis 426. The bore 420 is rotationally symmetric about the dosing module mount axis 426. Similarly, a first recess 421, which extends from the bore 420, is also rotationally symmetric about the dosing module mount axis 426. This is also visible in FIG. 11.

Returning to FIG. 12, the bore 420, or first recess, has a first diameter 428. The second recess 421 has a second diameter 430. The second recess 421 extends axially from the bore 420 (the bore 420 being proximate the connection adapter passage 414). The second diameter 430 is greater than the first diameter 428. A stepped portion 432 is defined between the bore 420 and the second recess 421 (i.e. where a diameter of overall cavity defined by both the bore 420 and the second recess 421 increases from the first diameter 428 to the second diameter 430). Said stepped portion 432 may seat a gasket, such as a graphite gasket, between part of the dosing module and the stepped portion 432.

As shown in both FIGS. 11 and 12, a distal end 419 of the boss 418 (i.e. an axially outermost end of the boss 418) further comprises a flange 434. The flange 434 is a region of the boss 418 which protrudes radially outwards from the dosing module mount axis 426. The flange 434 has an outer face 435 which defines an engagement surface which a dosing module (e.g. a corresponding flange thereof) can engage. In one embodiment, a clamp, such as a V-band clamp, may be secured over the flange 434 of the dosing module mount 416 and a corresponding flange of a dosing module to secure the flanges in abutment with one another (thereby securing the dosing module to the dosing module mount 416).

The stepped portion 432 and/or the outer face 435 of the flange 434 may be machined, e.g. in a milling process, to improve the surface finish for sealing and/or tolerance reasons.

In other embodiments, the dosing module mount may comprise holes or recesses where fasteners, such as bolts, can be used to secure the dosing module to the dosing module mount. Similarly, the boss may comprise a threaded surface which a complementary thread, provided on a dosing module mount, can threadably engage to secure the dosing module. In particular, a threaded surface may be provided on an internal surface of the boss (e.g. at least partway along the bore 420 and/or second recess 421) and/or an external surface of the boss.

Although the above description has related to dosing module mounts 122, 416 provided as part of a connection adapter, it will be appreciated that the dosing module mounts may otherwise form part of a monoblock turbine housing, or a conduit downstream of a turbine housing or turbine housing assembly.

FIG. 13 is a side view of a turbine dosing system 502, for a turbocharger, according to another embodiment.

The turbine dosing system 502 comprises a turbine housing 504 (forming part of a turbine 503), and a conduit 506 connected to an end of the turbine housing 504.

The turbine housing 504 defines a turbine inlet passage 508, a turbine wheel chamber 510 and part of a turbine outlet passage 512. In particular, the turbine housing 504 defines an upstream portion 512a of the turbine outlet passage 512. Although the aforementioned numerals are indicated on an exterior of the turbine dosing system 502, it will be appreciated that references to passages, and the wheel chamber, refer to internal features which are not visible in FIG. 13.

The turbine housing 504 functions in the same way as the turbine housing 102 described in connection with earlier Figures. However, the turbine housing 504 monoblock is not connected to a separate connection adapter. The turbine housing 504 may therefore be cast as a single, monolithic structure. The turbine 503 is a waste-gated turbine (as indicated by actuation rod 505). However, in other embodiments the turbine 503 may not incorporate a wastegate assembly. The turbine 503 may be a variable geometry turbine.

As exhaust gas flows downstream of the turbine wheel, and so turbine wheel chamber 510, it passes into the upstream portion 512a of the turbine outlet passage 512 (as defined by the turbine housing 504).

In the illustrated embodiment, the conduit 506 defines a downstream portion 512b of the turbine outlet passage 512. Said downstream portion 512b of the turbine outlet passage 512 may be described as a conduit passage. The turbine outlet passage 512, extending from the turbine housing 504 and through the conduit 506, defines a flow axis 516. As described in connection with earlier embodiments, the flow axis 516 extends from a downstream point of the turbine wheel and defines a centerline of the turbine outlet passage 516. As will be appreciated from the shape of the conduit 506, the downstream portion 512b of the turbine outlet passage 512 diverges proximate the dosing module 522. The conduit 506 therefore defines at least part of a diffuser downstream of the turbine housing 504. A cross-sectional area of the turbine outlet passage 512 becomes constant downstream of the downstream portion 512b of the turbine outlet passage 512. The conduit 506 may therefore be said to define a diffuser of the turbine 503.

The conduit 506 comprises a bend 518. The conduit 506 is therefore configured to direct exhaust gas flow, received from the turbine housing 504, in a direction which deviates from the turbine wheel axis 514. This is indicated by the flow axis 516, proximate the bend 518, which deviates from the linear trajectory of the turbine wheel axis 514. The conduit 506 may be manufactured from stainless steel, or incorporate a stainless steel lining, for reasons of corrosion resistance. A stainless steel lining may be present at the bend 518 (where build-ups/deposits, formed by the aftertreatment and associated byproducts, are most likely to gather).

The conduit 506 further comprises a dosing module mount 520. The dosing module mount 520 engages a (self-atomising) dosing module 522. The dosing module 522 is configured to inject aftertreatment fluid into the exhaust gas in the downstream portion 512b of turbine outlet passage 512 through an opening (not shown) in a wall of the conduit 506. The dosing module mount 522 is provided upstream of the bend 518 in the conduit 506. The dosing module mount 520 is angled such that aftertreatment fluid from the dosing module 522 is injected in a generally downstream direction, away from the turbine housing 504. In other embodiments, the dosing module mount 520 and the dosing module 522 may be configured to inject the aftertreatment fluid in a generally upstream direction, towards the turbine housing 504.

Owing to incorporation of the dosing module mount 520 as part of the conduit 506, and the associated location of the dosing module 522 along the conduit 506, the conduit 506 may be described as an aftertreatment fluid dosing conduit.

By providing the dosing module 522 in close proximity to the turbine wheel (less than around two exducer diameters in the illustrated embodiment), the advantages mentioned earlier in this document, including uniform mixing of aftertreatment fluid and decomposition of the urea therein, are also obtained using the turbine dosing system 502.

The dosing module mount 520 is integrally formed with the conduit 506. In other words, the dosing module mount 520 and the conduit 506, which defines the downstream portion 512b of the turbine outlet passage 512, are a unitary structure. Accordingly, the dosing module mount 520 and the conduit 506 may be formed by casting a single structure. Because aftertreatment fluid is injected into the exhaust gas flow in the conduit 506, the conduit 506 may be formed from, or lined with, stainless steel. Stainless steel is resistant to corrosion from the byproducts of aftertreatment fluid which may impinge on the conduit and could otherwise lead to corrosion.

A first, upstream end 524 of the conduit 506 engages a downstream end 526 of the turbine housing 504. The first end 524 of the conduit 506 may be said to comprise a connection portion, which facilitates securing the conduit 506 to the turbine housing 504. The conduit 506 may be secured to the turbine housing 504 using one or more fasteners (e.g. bolts) and/or a clamp (e.g. a V-band clamp). In order to provide a secure seal between the conduit 506 and the turbine housing 504, a gasket may be provided at the junction between the conduit 506 and the turbine housing 504, thereby mitigating against any fluid leakage at said junction.

FIG. 14 is a perspective view of a turbocharger 600 comprising a turbine dosing system 602 according to another embodiment.

The turbocharger 600 comprises a turbine 603 and compressor 601. The turbine 603 of FIG. 14 is similar to the turbine 503 of FIG. 13. Accordingly, for brevity only the differences between the turbine dosing systems 502 and 602 in FIGS. 13 and 14 are described below.

The turbine dosing system 602 differs from the turbine dosing system 502 of FIG. 13 in that the conduit 606 does not comprise a bend. Instead, a flow axis 616, defined by the conduit 606, is generally axial and is generally coincident with a turbine wheel axis 614. It will be appreciated that the flow axis 616 does diverge slightly from the turbine wheel axis 614 (e.g. a kink, or dogleg, 617 is present). However, this small divergence does not constitute a bend 518 as shown in FIG. 13, whereby the flow axis 516 of the turbine outlet passage 512b entirely changes direction (i.e. by more than around 45 degrees) from the turbine wheel axis 514.

Returning to FIG. 14, the turbine dosing system 602 also differs from the turbine dosing system 502 of FIG. 13 in that the dosing module mount 620 is not integrally formed with the conduit 606. Instead, the dosing module mount 620 is (initially) a separate component to that of the conduit 606, and is attached to the conduit 606 in a subsequent joining process (for example, by welding).

The conduit 606 also has a connection portion defined at a first end thereof, configured to engage a turbine housing. The conduit 606 defines a conduit passage.

FIG. 15 is a cross-section side view of part of a turbocharger 650 incorporating a turbine dosing system 652 according to another embodiment. In FIG. 15 a compressor, among other components, of the turbocharger 650 is omitted.

The turbine dosing system 652 comprises a turbine housing 654 (forming part of a turbine 656), a conduit 658 connected to the turbine housing 654, and a dosing module 655 mounted to the conduit 658.

The turbine housing 654 defines a turbine inlet passage 660, a turbine wheel chamber 662 and part of (e.g. an upstream portion of) a turbine outlet passage 664. In particular, the turbine housing 654 defines an upstream portion 666 of the turbine outlet passage 664, and the conduit 658 defines a downstream portion 668 of the turbine outlet passage 664. The downstream portion 668 of the turbine outlet passage 664 may be described as a conduit passage.

The turbine 656 of FIG. 15 is similar to the turbine 503 of FIG. 13 and turbine 603 of FIG. 14 for at least the reason that at least part of a diverging portion of the turbine outlet passage (e.g. a diffuser) is not defined by the turbine housing.

The turbine dosing system 652 differs from the turbine dosing system 502 in FIG. 13 and the turbine dosing system 602 in FIG. 14 in that the conduit 658 does not comprise a bend (e.g. as shown in FIG. 13) or kink (e.g. as shown in FIG. 14). Instead, a flow axis 670 remains coaxial with a turbine wheel axis 672.

The cross sectional area of the downstream portion 668 of the turbine outlet passage 664, defined by the conduit 658, increases linearly from where the conduit 658 is connected to the turbine housing 654 towards a downstream end of the conduit 658. At a downstream-most-end of the conduit 658, indicated by label 674, the cross sectional area of the turbine outlet passage 664 defined by the conduit 658 becomes constant (i.e. ceases to diverge).

The conduit 658 comprises a flange 676 (e.g. a connection portion) at the downstream end 674 which allows for additional downstream conduits to be readily connected to and/or mounted onto the conduit 658. Advantageously, different downstream conduits may be provided for different systems (e.g. having different space requirements), without the need to modify the turbine dosing system 652.

Although FIGS. 13, 14 and 15 refer to a conduit 506, 606 and 658, it will be appreciated that the conduits 506, 606, 658 may be interchangeably referred to as a downpipe and/or a downstream conduit. In general, the purpose of the conduit(s) is to facilitate the passage of exhaust gas (and aftertreatment fluid) towards a downstream SCR catalyst (not shown in any of FIG. 13, 14 or 15). The conduits may be referred to as aftertreatment fluid dosing conduits. The conduit 658 may be described as an upstream portion of a multi-piece conduit.

FIG. 16 is an enlarged view of a dosing module mount 710, a dosing module 712, and part of a surrounding structure of a connection adapter 716 forming part of a turbine dosing system according to another embodiment.

The dosing module mount 710 may form part of a conduit of the types shown in FIGS. 13 and 14, or may form part of a monoblock turbine housing as shown in FIG. 17.

Returning to FIG. 16, the connection adapter 716 shares many features in common with the connection adapters described earlier in this document. Similarly, the dosing module mount 710 shares many features in common with the dosing module mounts described earlier in this document. However, a primary difference is that the dosing module mount 710 is not integral with the surrounding structure of the connection adapter 716. Instead, the dosing module mount 710 is connected to the surrounding structure of the connection adapter 716 by a joining process such as, for example, welding.

The dosing module mount 710 has a bottle-cap-like structure. That is to say, the dosing module mount 710 is shaped like a hollow cylinder with one end face missing. The dosing module mount 710 thus has an open end 728 and a generally closed end 730. A bore 732, which may be described as a second recess, extends from the open end 728 to the closed end 730. The bore 732 receives at least a dosing end 734 of the dosing module 712.

The connection adapter 716 comprises a wall 718, which may otherwise be described as the structure surrounding the dosing module mount 710 once installed. The wall 718 defines at least part of a turbine outlet passage 720 when the connection adapter 716 is installed as part of a turbine dosing system. The turbine outlet passage 720 is configured to receive exhaust gas from a turbine housing 722.

An opening 714 is defined in the wall 718 of the connection adapter 716. Part of the dosing module mount 710 is received through the opening 714. A locating collar 715 of the dosing module mount 710 overhangs the opening 714, and engages the wall 718, to locate the dosing module mount 710 with respect to the connection adapter 716. This interaction also locates the dosing module 712 when received in the dosing module mount 710. The dosing module mount 710 may form an interference fit with the wall 718 of the connection adapter 716.

The closed end 730 comprises an outlet opening 742. The outlet opening 742 defines a first recess 743. The first recess 743 is configured to receive a nozzle 713 of the dosing module 712. The nozzle 713 of the dosing module 712 defines an outlet 736 of the dosing module 712. The first recess 743 has a minimum diameter that is substantially equal to the diameter of the nozzle 713 of the dosing module 712. The outlet 736 of the dosing module 712 lies within the first recess 743 of the dosing module mount 710. In other words, the outlet 736 of the dosing module 712 is, at most, flush with the closed end 730 of the dosing module mount 710 (and may be recessed relative to the closed end 730).

The dosing module 712 ejects aftertreatment fluid from the outlet 736 as a fine spray in a generally conical manner. Such a spray cone is labelled 738 in FIG. 15. The dosing module 712 defines a dosing module axis 740, which extends through the centroid (i.e. geometric centre) of the outlet 736 of the dosing module 712. The outlet 736 of the dosing module 712, the outlet opening 742 of the dosing module mount 710 and the opening 714 in the connection adapter are all concentric about the dosing module central 740.

The closed end 730 of the dosing module mount 710 is disposed through the opening 714 of the wall 718. The closed end 730 thus projects into the turbine outlet passage 720. Accordingly, there is a direct fluid pathway from the outlet 736 of the dosing module 712 to the turbine outlet passage 720 (via the first recess 743). The dosing module 712 is configured to inject aftertreatment fluid directly into an exhaust gas flow in the turbine outlet passage 720.

The open end 728 of the dosing module mount 710 defines a flange 744. The flange 744 extends radially outwards, relative to the dosing module axis 740, around a perimeter of the dosing module mount 710. The flange 744 has an end face 745. The dosing module 712 comprises a dosing module flange 746. The dosing module flange 746 extends radially outwards, relative to the dosing module central axis 740, around a perimeter of the dosing module 712. The flanges 744, 746 engage one another to locate the dosing module 712 within the dosing module mount 710. Specifically, a (downwardly-facing) end face 747 of the dosing module flange 746 abuts the (upwardly-facing) end face 745 of the flange 744 of the dosing module mount 710.

To secure the dosing module 712 to the dosing module mount 710, a clamp 726 is used. The clamp 726 is a V-band clamp. The clamp 726 retains the flange 744 of the dosing module mount 710 and the dosing module flange 746 in engagement with one another.

The clamp 726 is tightened via an adjustable screw 748. The clamp 726 extends around the dosing module axis 712. U-shaped body 727, of the clamp 726, urges the flanges 744, 746 towards one another. It will be appreciated that in a method of installing the dosing module 712, before the clamp 726 is secured the dosing module 712 is urged into engagement with the dosing module mount 710. Specifically, the flange 474 is brought into abutment with the flange 745 to align the dosing module 712 using the dosing module mount 710.

FIG. 17 is a perspective view of a turbocharger 800 incorporating a turbine dosing system 801 according to another embodiment.

The turbocharger 800 comprises the turbine dosing system 801, comprising a turbine housing 802, and a compressor 803, comprising a compressor housing 804. The turbine housing 802 and the compressor housing 804 are interconnected by a bearing housing 805.

The turbine housing 802 is a monoblock turbine housing, meaning that the turbine housing 802 is formed as a single, unitary structure (i.e. not a combination of a turbine housing and a connection adapter, like that shown in FIG. 4). Each of a turbine inlet passage 806, wheel chamber 808 and turbine outlet passage 810 is defined by the turbine housing 802. Accordingly, the turbine housing 802 may be cast as a single, monolithic structure. The turbine housing 802 may be cast from stainless steel, for reasons of corrosion resistance. The turbine housing 802 may comprise a stainless steel liner e.g. at a primary impingement zone (e.g. where spray 822 hits an opposing surface) and/or at a joint line with a downstream component.

The turbine outlet passage 810 is defined by a wall 812 of the turbine housing 802. A cross sectional area of the turbine outlet passage 810 increases, along flow axis 807, from an upstream end, proximate the turbine wheel chamber 808, to a downstream end, along a diverging portion of the turbine outlet passage 810. As such, the turbine housing 802 defines a diffuser. As exhaust gas flows through the turbine outlet passage 810, the velocity of the exhaust gas decreases and the total static pressure increases owing to the diverging turbine outlet passage 810. The turbine outlet passage 810 may otherwise be described as a turbine housing outlet passage.

The turbine housing 802 further comprises a dosing module mount 814. The dosing module mount 814 is integral with the structure of the turbine housing 802 which defines the turbine outlet passage 810 (e.g. the wall 812). The dosing module mount 814 receives a dosing module 816, and the dosing module 816 is configured to inject aftertreatment fluid into the exhaust gas into turbine outlet passage 810.

The dosing module 816 is a self-atomising dosing module meaning that it is configured to eject aftertreatment fluid from an outlet (not visible) of the dosing module 816 as a fine spray. A spray cone (of aftertreatment fluid) is schematically indicated in FIG. 16 and is labelled 822. The dosing module 816 injects atomised aftertreatment fluid through an opening (not visible) in the wall 812 into the bulk exhaust gas flow in the turbine outlet passage 810. The dosing module 816 may be described as being mounted within the turbine housing 802. The dosing module 816 preferably injects aftertreatment fluid into a diverging portion of the turbine outlet passage 810.

By forming the turbine housing 802 and the dosing module mount 814 as a single, integrated structure, the dosing module 816, specifically the outlet thereof, can be placed in closer proximity to the turbine wheel (yet still downstream of the turbine wheel to mitigate against the risk of any corrosive aftertreatment fluid impinging on the turbine wheel, as well as avoiding rotational imbalance of the turbine wheel and reduced radial loading of turbine shaft bearings). Aftertreatment fluid can thus be injected into exhaust gas flow that has a relatively high turbulent kinetic energy, which promotes uniform mixing of the aftertreatment fluid with the exhaust gas. The risk of aftertreatment fluid impinging on an opposing surface of the turbine housing 802, and an associated build-up of solid deposits occurring (with inherent corrosion risks), is thereby reduced. Furthermore, there is no joint between the structure in which the dosing module mount 814 is provided and the structure defining the wheel chamber. The risk of leakage and/or deposit buildup at the joint is thus eliminated.

FIG. 18 is a plot showing the variation of turbulent kinetic energy of exhaust gas, downstream of a turbine wheel, obtained from a CFD simulation conducted on a turbine dosing system 901 according to another embodiment. FIG. 19 is a plot showing the variation of exhaust gas for the same turbine dosing system 901.

The turbine dosing system 901 comprises a turbine housing 902 and a turbine wheel 904 (configured to rotate about a turbine wheel axis 906). An exducer diameter 916, of the turbine wheel 904, is labelled in FIG. 18.

Downstream of the turbine wheel 904, the turbine housing 902 defines part of a turbine outlet passage 908. The turbine outlet passage 908 defines a flow axis 910. The flow axis 910 is initially aligned with the turbine wheel axis 906, where the turbine outlet passage 908 is generally axial. However, where the turbine outlet passage 908 comprises a bend 912, the flow axis 910 deviates away from the turbine wheel axis 906 so as to follow the bend 912 of the turbine outlet passage 908.

FIG. 18 illustrates how a zone of high turbulent kinetic energy exists within the turbine outlet passage 908. The zone begins at around 0.5 exducer diameters along the flow axis 910 (e.g. from the most downstream point of the turbine wheel 904), as indicated by the arrow 918. Almost all of the exhaust gas flow in the turbine outlet passage 908 has a high level of turbulent kinetic energy until approximately four exducer diameters from the turbine wheel 904, measured along the flow axis 910, as indicated by the arrow 920. The turbulent kinetic energy of the exhaust gas flow reduces significantly downstream of the bend 912 in the turbine outlet passage 908. At around six exducer diameters from the turbine wheel 904 around half of the exhaust gas flow has a high turbulent kinetic energy. By around nine exducer diameters, the turbulent kinetic energy of the exhaust gas flow has dropped to a medium-high level.

An opening 924, in a wall of the turbine housing 902, is illustrated such that aftertreatment fluid can be injected by a dosing module (not shown) into a region of exhaust gas flow with a relatively high turbulent kinetic energy.

It will be appreciated, from FIG. 18, why placement of the dosing module with respect to the downstream end of the turbine wheel 904 has a significant effect upon the level of at least turbulent kinetic energy in the exhaust gas flow at that position (and so the level of mixing of the aftertreatment fluid with the exhaust gas).

Turning to FIG. 19, a plot showing the variation of velocity of the exhaust gas flow in the turbine dosing system 901 is provided. When comparing FIG. 19 with FIG. 18 (both drawn to the same scale), it can be seen that in the region where the exhaust has a highest turbulent kinetic energy, the velocity is relatively low due to the presence of turbulent vortices (eddies) as indicated by the arrows 930. The turbulent vortices 930 promote the mixing of injected aftertreatment fluid with exhaust gas, such that the aftertreatment fluid is uniformly distributed in the exhaust gas.

Where the turbine outlet passage 908 comprises a bend 912 it is beneficial to inject aftertreatment fluid upstream of the bend 912 (e.g. to position the dosing module upstream of the bend). As shown in FIGS. 18 and 19, the energy of the exhaust gas flow dissipates, and the velocity decreases, respectively, downstream of the bend 912 in the turbine outlet passage 908.

Injecting aftertreatment fluid into the turbine outlet passage 908 at a distance that is up to around ten exducer diameters, preferably between around two and around five exducer diameters, of the turbine wheel 904 from the most downstream point of the turbine wheel 904, when measured along the flow axis 910, has been found to be advantageous for reasons of improved mixing.

It can also be seen that, upstream of the bend 912, proximate the wall surface 929 which defines the turbine outlet passage 908, there is a zone 931 of exhaust gas which has a ‘medium’ velocity. This zone 931 of medium velocity exhaust gas flow assists in preventing deposit formation on the wall surface 929. This is at least partly due to a shearing force generated by the exhaust gas in the zone 931 at the wall surface 929, which prevents settlement of aftertreatment fluid thereon. The medium velocity exhaust gas zone 931 also heats the wall surface 929 (by a convective heating process) which, in turn, promotes evaporation of aftertreatment fluid. However, it can be seen that this zone 931 of medium velocity exhaust gas near the wall 929 surface dissipates downstream of the bend 912 (e.g. the velocity of exhaust gas proximate the wall surface reduces downstream of the bend 912). For the reasons set out above it is desirable to inject aftertreatment fluid into the turbine outlet passage 908 upstream of the bend 912.

The aftertreatment fluid may be injected into the turbine outlet passage 908 at least around 0.5 exducer diameters of the turbine wheel 904 downstream of the turbine wheel 904. In general, the aftertreatment fluid will not be injected more than around 10, preferably not more than around 5, exducer diameters downstream of the turbine wheel 904, and is preferably injected upstream of a (first) bend 912. Four exducer diameters are indicated, along the flow axis 910, in FIGS. 18 and 19. Injecting aftertreatment fluid in the above described regions (and so positioning the dosing module, and dosing module mount, in the same regions) allows the high energy exhaust gas to be utilised before viscous effects (e.g. friction between and wall and the exhaust gas) and heat transfer dissipate the exhaust gas flow energy and cause the temperature and velocity of the exhaust gas flow to drop (with an associated reduction in mixing efficiency).

FIGS. 20 to 23 show a further embodiment of a turbine dosing system 7000. The turbine dosing system 7000 comprises a turbine housing 7002, a turbine wheel (not shown), a wastegate arrangement 7004, a connection adapter 7006, a dosing module 7008, and a NOx sensor 7010 (see FIGS. 21 and 23). The combination of the turbine housing 7002 and connection adapter 7006 define a turbine housing assembly 7001.

The turbine housing 7002 defines a pair of inlet volutes 7012 (which may be referred to as a turbine inlet passage) and a turbine wheel chamber 7014. In other embodiments, the turbine housing 7002 may define a single inlet volute (which may be referred to as a turbine inlet passage). Although the turbine wheel is not shown, it will be appreciated that during use the turbine wheel sits within the turbine wheel chamber 7014 where it is supported for rotation relative to the turbine housing 7002 by a shaft (not shown) about a turbine axis 7015. Exhaust gas received from an internal combustion engine (not shown) is delivered via the inlet volutes 7012 to the turbine wheel chamber 7014 whereupon the momentum of the exhaust gas impacts the blades of the turbine wheel to generate rotation of the turbine wheel and shaft.

The connection adapter 7006 is connected to the turbine housing 7002 such that the turbine housing 7002 and connection adapter 7006 in combination define part of a turbine outlet passage 7016. The connection adapter 7006 is coupled to the turbine housing 7002 by a plurality of fasteners (one of which is labelled 7041 in FIG. 59), but could otherwise be coupled by way of a clamp or other connection mechanism. The first and/or second connection portions (where appropriate) may therefore comprise a flange with one or more bores. The turbine outlet passage 7016 receives exhaust gas that has passed through the turbine wheel from the turbine wheel chamber 7014. The turbine outlet passage 7016 comprises a first, upstream portion 7018 that extends axially, in relation to the turbine axis 7015, along a first portion 7021a of a flow axis 7021. The turbine outlet passage further comprises a second, downstream portion 7020, extending along a second portion 7021b of the flow axis 7021. The second portion 7020 may be referred to as a connection adapter passage. The second portion 7020 is generally angled relative to the first portion 7018 along the flow axis 7021. The angular difference between the first and second portions 7018, 7020 (i.e. between the first and second portions 7021a, 7021b of the flow axis 7021) is approximately 30°, however this may be varied to suit any particular packaging requirements. In some embodiments, the second portion 7020 of the turbine outlet passage 7016 may be completely axial relative to first portion 7018 (and optionally the turbine axis 7015) such that it does not comprise any relatively angled portions. This may be described as a linearly extending turbine outlet passage or connection adapter (e.g. see FIG. 4).

The first portion 7018 of the turbine outlet passage 7016 is defined by the turbine housing 7002 and the second portion 7020 of the turbine outlet passage 7016 is defined by the connection adapter 7006. The second portion 7020 of the turbine outlet passage 7016 receives exhaust gas from the first portion 7018. The first portion 7018 comprises a first diffuser section 7022 and the second portion 7020 comprises a second diffuser section 7024. The first and second diffuser sections 7022, 7024 are regions of the turbine housing 7002 and connection adapter 7006 respectively in which the flow area of the turbine outlet passage 7016 (i.e. the cross-sectional area relative to the direction of flow) increases with distance from the turbine wheel. Both the turbine housing 7002 and connection adapter 2006 may therefore be described as defining at least part of, or an entirety of, a diffuser of a turbine housing assembly (e.g. a turbine comprising a turbine housing and a connection adapter).

The wastegate arrangement 7004 comprises a wastegate passage 7026 that extends between the turbine inlet volutes 7012 and the turbine outlet passage 7016. The wastegate arrangement 7004 further comprises a pair of wastegate valves 7028 which cover respective valve openings (not shown) so as to selectively permit or prevent the flow of exhaust gas through the wastegate passage 7026. The valve openings connect separately to each of the 7012 inlet volutes (e.g. the turbine inlet passage). The wastegate valves 7028 are mounted to a common actuator (not shown) and are controlled in unison. However, in alternative embodiments, the valves may be controlled separately. The valve openings are generally the same size, however in alternative embodiments the valve opening may be asymmetric. Moreover, the valve openings may be operated using a single valve head rather than a pair of valves 7028. During use, when the wastegate valves 7028 are open, exhaust gas from the inlet volutes 7012 is bypassed to the turbine outlet passage 7016, via the wastegate passage 7026, without passing through the turbine wheel chamber 7014 and across the turbine wheel.

The wastegate passage 7026 is partially defined by the connection adapter 7006. In particular, the wastegate passage 7026 joins the turbine outlet passage 7016 at a wastegate passage outlet 7030. The wastegate passage outlet 7030 is defined in a side wall 7035 of the connection adapter 7006 and is positioned approximately at the apex of the angular bend defined between the first and second portions 7018, 7020 of the turbine outlet passage 7016 (i.e. approximately at the point where the first and second portions 7021a, 7021b of the flow axis 7021 meet). The wastegate passage 7026 defines a wastegate flow axis 7032 at the wastegate passage outlet 7030. The wastegate flow axis 7032 defines the direction of flow of exhaust gas from the wastegate passage 7026 as it joins the turbine outlet passage 7016. In the present embodiment, the wastegate flow axis 7032 is angled relative to the first portion 7021a of the flow axis 7021 (or the turbine wheel axis 7015) by approximately 45°. However, in alternative embodiments substantially any angle may be used. In the illustrated embodiment the wastegate flow axis 7032 is angled in a downstream direction. As shown in FIG. 21, in this embodiment the wastegate passage outlet 7030 has a more square geometry than the rectangular wastegate passage outlet 138 shown in FIG. 4.

The connection adapter 7006 comprises a mount 7034 (see FIG. 22) for the dosing module 7008. The mount 7034 defines an opening 7036 an opening 7036 with which a nozzle 7038 of the dosing module 7008 is concentrically aligned (albeit recessed relative thereto). The nozzle 7038 is positioned so that it is radially outwards of the side wall 7035 of the connection adapter 7006. However, in other embodiments the nozzle 7038 may be substantially aligned (e.g. flush) with the side wall of the connection adapter 7006.

The opening 7036 is positioned within the second diffuser section 7024. The nozzle 7038 is configured to generate a spray of aftertreatment fluid which is directed into the turbine outlet passage 7016 along a spray axis 7040 (which may otherwise be referred to as a dosing module axis). The spray axis 7040 is angled in a downstream direction with respect to the second portion 7021b of the flow axis 7021. The angle 7041 is around 7° with respect to orthogonal to the second portion 7021b of the flow axis 7021 in the illustrated embodiment. However, in other embodiments the spray axis 7040 may be angled at a different angle to the axis 7021 (e.g. orthogonal, or be angled in an upstream direction). The spray of aftertreatment fluid defines a spray region (e.g. spray cone) 7042, the presence of which is shown schematically by dotted lines in FIGS. 20 and 22. A primary impingement zone 7043 is defined on the opposing surface of the side wall 7035 to that of the dosing module mount 7034 (e.g. bound by the spray region 7042).

Returning to FIG. 20, the mount 7034 (not labelled in FIG. 20, but labelled in FIG. 22) and opening 7036 for the dosing module 7008 are positioned on substantially the opposite side of the turbine outlet passage 7016 to the wastegate passage outlet 7030. Moreover, the mount 7034 and opening 7036 for the dosing module 7008 are positioned downstream of the wastegate passage outlet 7030. The position of the wastegate passage outlet 7030 relative to the spray region 7042 and the angle of the wastegate flow axis 7032 relative to the spray region 7042 are such that, during use, when the wastegate valves 7028 are open, exhaust gas that has passed through the wastegate passage 7026 is directed into the spray region 7042 so that it fluidically exchanges momentum with the injected aftertreatment fluid.

The mount 7034 and opening 7036 for the dosing module 7008 are positioned within and/or form part of the connection adapter 7006. However, in alternative embodiments the mount 7034 and opening 7036 for the dosing module 7008 may be positioned within and/or form part of the turbine housing 7002. Because the mount 7034 and opening 7036 for the dosing module 7008 are positioned within the connection adapter 7006 or the turbine housing 7002, this means that the dosing module 7008 is positioned close to the turbine wheel. Accordingly this means that the injected aftertreatment fluid may take advantage of high exhaust gas temperatures which aid evaporation and decomposition. In this regard, the mount 7034, opening 7036 and dosing module 7008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 7022. The exducer diameter 176 is also schematically indicated in FIG. 4, for completeness. In the illustrated embodiment the mount 7034, opening 7036 and dosing module 7008 are positioned at a distance of around 3.3 exducer diameters downstream of the downstream end of the turbine wheel chamber (and wheel). This distance is schematically indicated by construction line 7023.

The connection adapter 7006 comprises a sensor conduit 7044 (which may be referred to as an exhaust gas channel). The sensor conduit 7044 comprises a sensor conduit inlet 7046, configured to receive an aliquot of exhaust gas from the turbine outlet passage 7016, and a sensor conduit outlet 7048, configured to re-introduce exhaust gas from the sensor conduit 7044 to the turbine outlet passage 7016. The sensor conduit 7044 defines a flow area that is larger than the size of the sensor conduit inlet 7046. Accordingly, the sensor conduit 7044 acts to decelerate the exhaust gas passing therethrough. The sensor conduit 7044 comprises a mount 7050 (see FIG. 23) configured to receive the NOx sensor 7010. The NOx sensor 7010 comprises a sensing tip 7052 which protrudes into the interior of the sensor conduit 7044. Because the geometry of the sensing conduit 7044 decelerates the exhaust gas passing therethrough, the sensing tip 7052 is exposed to lower velocity exhaust gas, thus reducing the risk of damage to the sensing tip 7052 and improving the accuracy of sensor readings.

With reference to FIG. 20, the sensor conduit inlet 7046 is positioned upstream of the opening 7036 for the dosing module 7008. Put another way, the primary impingement zone 7043 does not overlap the sensor conduit inlet 7046. Accordingly, the risk of aftertreatment entering the sensor conduit 7044 and adversely affecting readings taken by the NOx sensor 7010 is eliminated. The sensor conduit 7044 is part of the second diffuser section 7024. However, in alternative embodiments the sensor conduit 7044 may be part of the first diffuser section 7022.

Various aspects described and illustrated in connection with the embodiment shown in FIGS. 20 to 23, such as the first and second portions 7018, 7020 of the turbine outlet passage 7016 being angled relative to one another, may be incorporated in any other embodiments described herein.

The turbine dosing system 7000 embodies various aspects of the invention including, but not limited to:
The first to fourth aspects of the invention;
The sixth aspect of the invention; and
The eighth and ninth aspects of the invention.

FIG. 24 shows a further embodiment of a turbine dosing system 8000. The turbine dosing system 8000 comprises a turbine housing 8002, a turbine wheel (not shown), a variable geometry mechanism (not shown), a connection adapter 8006, a dosing module 8008 (shown in FIGS. 25 and 26), and a NOx sensor 8010.

In contrast to many of the earlier embodiments, the turbine dosing system 8000 does not comprise a wastegate arrangement. Instead, the variable geometry mechanism (which, as mentioned above, is not shown) is used to control the RPM of the turbine wheel.

The turbine housing 8002 defines an inlet volute 8012 (which may be referred to as a turbine inlet passage) and a turbine wheel chamber 8014. In other embodiments, the turbine housing 8002 may define more than one inlet volute 8012. Although the turbine wheel is not shown, it will be appreciated that during use the turbine wheel sits within the turbine wheel chamber 8014 where it is supported for rotation relative to the turbine housing 8002 by a shaft (not shown) about a turbine axis 8015. Exhaust gas received from an internal combustion engine (not shown) is delivered via the inlet volute 8012 to the turbine wheel chamber 8014 whereupon the momentum of the exhaust gas impacts the blades of the turbine wheel to generate rotation of the turbine wheel and shaft.

The connection adapter 8006 is connected to the turbine housing 8002 such that the turbine housing 8002 and connection adapter 8006 in combination define part of a turbine outlet passage 8016. The connection adapter 8006 is coupled to the turbine housing 8002 by a clamp 8041, but could otherwise be coupled by way of a plurality of fasteners or other connection mechanism. The clamp 8041 draws a first connection portion (e.g. flange) 8007 of the connection adapter 8006 into engagement with a first connection portion (e.g. flange) 8003 of the turbine housing 8002. The turbine outlet passage 8016 defines a flow axis 8017, the flow axis 8017 extending from a downstream end of the turbine wheel chamber 8014. The turbine outlet passage 8016 receives exhaust gas that has passed through the turbine wheel from the turbine wheel chamber 8014. The turbine outlet passage 8016 comprises a first portion 8018 defined by the turbine housing 8002, and a second portion 8020 that is defined by the connection adapter 8006 (which may be referred to as a connection adapter passage). The second portion 8020 of the turbine outlet passage 8016 receives exhaust gas from the first portion 8018. Put another way, the second portion 8020 is downstream of the first portion 8018. The first portion 8018 comprises a first diffuser section 8022 and the second portion 8020 comprises a second diffuser section 8024. The first and second diffuser sections 8022, 8024 are regions of the turbine housing 8002 and connection adapter 8006 respectively in which the flow area of the turbine outlet passage 8016 (i.e. the cross-sectional area relative to the direction of flow) increases with distance from the turbine wheel. The first and second diffuser sections 8022, 8024 are substantially continuous with one another so as to define a single continuous diffuser (of the overall turbine housing assembly 8001 defined by the combination of the turbine housing 8002 and the connection adapter 8006).

With reference to FIGS. 25 and 26, the connection adapter 8006 comprises a mount 8034 (which may be referred to as a dosing module mount) for the dosing module 8008. The mount 8034 defines an opening 8036 with which a nozzle 8038 of the dosing module 8008 is concentrically aligned (albeit recessed relative thereto). The nozzle 8038 is positioned so that it is radially outwards of the side wall 8035 of the connection adapter 8006. However in other embodiments the nozzle 8038 may be substantially aligned (e.g. flush) with the side wall 8035 of the connection adapter 8006. The opening 8036 is positioned within the second diffuser section 8024. The nozzle 8038 is configured to generate a spray of aftertreatment fluid which is directed into the turbine outlet passage 8016 along a spray axis 8040 (which may be referred to as a dosing module axis). The spray axis 8040 is angled in a downstream direction with respect to the flow axis 8017 in the illustrated embodiment. The angle 8041 is around 7° with respect to orthogonal to the flow axis 8017 in the illustrated embodiment. However, in other embodiments the spray axis 8040 may be angled at a different angle to the flow axis 8017 (e.g. orthogonal, or be angled in an upstream direction). The spray of aftertreatment fluid defines a spray region (e.g. spray cone) 8042, the presence of which is shown schematically by dotted lines in FIGS. 25 and 26. The mount 8034 and opening 8036 for the dosing module 8008 are positioned within the connection adapter 8006. However, in alternative embodiments the mount 8034 and opening 8036 for the dosing module 8008 may be positioned within the turbine housing 8002. A primary impingement zone 8043 is defined on the opposing surface of the side wall 8035 to that of the dosing module mount 8034 (e.g. bound by the spray region 8042).

Because the mount 8034 and opening 8036 for the dosing module 8008 are positioned within the connection adapter 8006 or the turbine housing 8002, this means that the dosing module 8008 is positioned close to the turbine wheel. Accordingly this means that the injected aftertreatment fluid may take advantage of high exhaust gas temperatures which aid evaporation and decomposition. In this regard, the mount 8034, opening 8036 and dosing module 8008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 8022. The exducer diameter 176 is also schematically indicated in FIG. 4, for completeness. In the illustrated embodiment, the mount 8034, opening 8036 and dosing module 8008 are positioned within around 1.7 exducer diameters of the downstream end of the turbine wheel and turbine wheel chamber 8014. In other embodiments, the mount 8034, opening 8036 and dosing module 8008 may be positioned anywhere up to around 2 exducer diameters of the downstream end of the turbine wheel and turbine wheel chamber 8014, and are preferably located at least 1 exducer diameter downstream of the downstream end of the turbine wheel and turbine wheel chamber 8014. For completeness, the downstream end of the turbine wheel and turbine wheel chamber 8014 are schematically indicated by construction line 8019 in FIG. 26. The around 1.7 exducer diameters length, along the flow axis 8017, is indicated by construction line 8021.

The connection adapter 8006 comprises a sensor conduit 8044 (which may be referred to as an exhaust gas channel) having a sensor conduit inlet 8046 (see FIG. 24) configured to receive an aliquot of exhaust gas from the turbine outlet passage 8016 and sensor conduit outlet 8048 configured to re-introduce exhaust gas from the sensor conduit 8044 to the turbine outlet passage 8016. The sensor conduit 8044 defines a flow area that is larger than the size of the sensor conduit inlet 8046. Accordingly, the sensor conduit 8044 acts to decelerate the exhaust gas passing therethrough. The sensor conduit comprises a mount 8050 configured to receive the NOx sensor 8010. The NOx sensor 8010 comprises a sensing tip 8052 which protrudes into the interior of the sensor conduit 8044. Because the geometry of the sensing conduit 8044 decelerates the exhaust gas passing therethrough, the sensing tip 8052 is exposed to lower velocity exhaust gas, thus reducing the risk of damage to the sensing tip 8052 and improving the accuracy of sensor readings.

With reference to FIGS. 25 and 26, the sensor conduit inlet 8046 is positioned upstream of the opening 8036 for the dosing module 8008. Put another way, the primary impingement zone 8043 does not overlap the sensor conduit inlet 8046. Accordingly, the risk of aftertreatment entering the sensor conduit 8044 and adversely affecting readings taken by the NOx sensor 8010 is eliminated. The sensor conduit 8044 is part of the second diffuser section 8024. However, in alternative embodiments the sensor conduit 8044 may be part of the first diffuser section 8022. For completeness, FIG. 26 is a cross-section side view taken through the dosing module 8008.

Various aspects described and illustrated in connection with the embodiment shown in FIGS. 24 to 26, such as the use of the variable geometry mechanism, and omission of a wastegate, may be incorporated in any other embodiments described herein (where appropriate).

The turbine dosing system 8000 embodies various aspects of the invention including, but not limited to:
The first to fourth aspects of the invention;
The sixth aspect of the invention; and
The eighth and ninth aspects of the invention.

Embodiments described in this application provide a number of advantages including: 1) improved mixing of aftertreatment fluid with an exhaust gas stream; 2) a reduction of deposits/build-ups at a surface generally opposite an outlet of the dosing module (owing to poor mixing of aftertreatment fluid with the exhaust gas); 3) improved packaging of the dosing module/mount; and 4) reducing unwanted system back pressure.

The described and illustrated embodiments are to be considered as illustrative and not restrictive in character, it being understood that only preferred embodiments have been shown and described and that all changes and modifications that come within the scope of the inventions as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

1. A turbine dosing system for a turbocharger, the turbine dosing system comprising:
a turbine inlet passage configured to receive exhaust gas from an internal combustion engine;
a turbine wheel chamber configured to receive exhaust gas from the turbine inlet passage, the turbine wheel chamber containing a turbine wheel supported for rotation about a turbine wheel axis, the turbine wheel comprising an exducer defining an exducer diameter; and
a turbine outlet passage downstream of the turbine wheel chamber and configured to receive exhaust gas from the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 10 exducer diameters, along the flow axis, downstream of the downstream end of the turbine wheel.

2. A turbine dosing system according to claim 1, further comprising a dosing module mounted to the dosing module mount and configured to inject aftertreatment fluid, via an outlet of the dosing module, into exhaust gas in the turbine outlet passage.

3.-5. (canceled)

6. A turbine dosing system according to claim 2, wherein the structure which at least partly defines the turbine outlet passage comprises an opening; and
the dosing module is configured to inject aftertreatment fluid through the opening.

7. A turbine dosing system according to claim 1, wherein the dosing module mount is located within around 5 exducer diameters, along the flow axis, downstream of the downstream end of the turbine wheel.

8. A turbine dosing system according to claim 2, wherein the dosing module mount comprises a first recess; and
wherein at least part of the dosing module is disposed in the first recess.

9. A turbine dosing system according to claim 2, wherein the outlet is substantially flush with an interior surface of the structure which at least partly defines the turbine outlet passage.

10. A turbine dosing system according to claim 1, wherein the turbine outlet passage at least partly diverges.

11. A turbine dosing system according to claim 10, wherein the dosing module mount is provided in a diverging portion of the turbine outlet passage.

12. A turbine dosing system according to claim 1, wherein the dosing module mount is integral with the structure which at least partly defines the turbine outlet passage.

13. (canceled)

14. A turbine dosing system according to claim 1, the turbine dosing system further comprising a turbine housing assembly, the turbine housing assembly comprising:
a turbine housing, the turbine housing defining the turbine inlet passage and the turbine wheel chamber; and
a connection adapter, the connection adapter being coupled to the turbine housing and at least partly defining the turbine outlet passage.

15. The turbine dosing system according to claim 14, wherein the connection adapter comprises the dosing module mount.

16.-17. (canceled)

18. A turbine dosing system according to claim 1, further comprising an exhaust gas sensor.

19. A turbocharger comprising:
a compressor, the compressor comprising a compressor housing and a compressor wheel;
a bearing housing, the bearing housing being configured to support a shaft for rotation about an axis; and
a turbine dosing system according to claim 1;
wherein the compressor wheel and turbine wheel are coupled to the shaft in power communication with one another.

20. An engine arrangement comprising;
an engine; and
a turbocharger according to claim 19;
wherein the turbocharger is configured to receive exhaust gas from the engine.

21. (canceled)

22. A connection adapter for an aftertreatment fluid dosing turbine housing assembly, the connection adapter comprising:
a first connection portion, at a first end of the connection adapter, configured to engage a turbine housing;
a second connection portion, at a second end of the connection adapter, configured to engage a downstream conduit;
a structure which extends between the first and second ends of the connection adapter and defines a connection adapter passage configured to receive exhaust gas from a turbine housing, the structure comprising a dosing module mount, the dosing module mount being configured to receive a dosing module, the dosing module mount being in communication with the connection adapter passage via an opening, defined in the structure, through which aftertreatment fluid is injectable into exhaust gas in the connection adapter passage.

23. (canceled)

24. A method of assembling the turbine dosing system according to claim 2, the method comprising:
urging the dosing module into engagement with the dosing module mount; and
securing the dosing module to the dosing module mount.

25. The method of claim 24, wherein securing the dosing module to the dosing module mount comprises placing, and tightening, a clamp around flanges of the dosing module and the dosing module mount.

26. A method of operating a turbine dosing system for a turbocharger, comprising:
receiving exhaust gas from an internal combustion engine into a turbine inlet passage;
receiving exhaust gas from the turbine inlet passage into a turbine wheel chamber, the turbine wheel chamber containing a turbine wheel supported for rotation about a turbine wheel axis, the turbine wheel comprising an exducer defining an exducer diameter; and
receiving exhaust gas from the turbine wheel chamber into a turbine outlet passage downstream of the turbine wheel chamber, the turbine outlet passage being at least partly defined by a structure which comprises a dosing module mount configured to receive a dosing module, the turbine outlet passage defining a flow axis which extends from a downstream end of the turbine wheel;
wherein the dosing module mount is located within around 10 exducer diameters, along the flow axis, downstream of the downstream end of the turbine wheel.

27. The method according to claim 26, further comprising a dosing module mounted to the dosing module mount, wherein the dosing module mount injects aftertreatment fluid, via an outlet of the dosing module, into exhaust gas in the turbine outlet passage.

28.-42. (canceled)

43. The method according to claim 26, further comprising sensing one or more properties of exhaust gas using an exhaust gas sensor.
